(19) United States
(12) Patent Application Publication
(10) Pub. No.: US 2026/0010115 A1
(43) Pub. Date: Jan. 8, 2026

(54) IMAGE FORMING APPARATUS

(71) Applicant: CANON KABUSHIKI KAISHA, Tokyo (JP)

(72) Inventors: SHUMA HIASA, Kanagawa (JP); TOMOYA TATEISHI, Kanagawa (JP); OSAMU SASAOKA, Kanagawa (JP); KOHEI KOGUCHI, Tokyo (JP); JUMPEI NITTA, Kanagawa (JP); TACHIO KAWAI, Tokyo (JP)

(21) Appl. No.: 19/325,301

(22) Filed: Sep. 10, 2025

Related U.S. Application Data
(63) Continuation of application No. PCT/JP2024/011838, filed on Mar. 26, 2024.

(30) Foreign Application Priority Data
Mar. 28, 2023 (JP) 2023-051818

(51) Int. Cl. G03G 21/16; G03G 15/08

(52) U.S. Cl. CPC G03G 21/1676; G03G 15/0875; G03G 2215/068; G03G 2221/163; G03G 2221/1815

(57) ABSTRACT

An image forming apparatus includes a rotary including a developing chamber, a cartridge configured to supply a developer to the developing chamber, and a tray capable of detachably supporting the cartridge. The tray includes a first opposed portion configured to be opposed to the cartridge and extend in a predetermined direction, and is disposed relative to the rotary to a first position where the cartridge is located outside the rotary and a second position where the cartridge is located inside the rotary. The predetermined direction is a detachment direction of the cartridge. With the cartridge supported by the tray, a part of the cartridge is located downstream, in the predetermined direction, of a downstream end of the first opposed portion in the predetermined direction.

### CROSS-REFERENCE TO RELATED APPLICATIONS

This application is a Continuation of International Patent Application No. PCT/JP2024/011838, filed Mar. 26, 2024, which claims the benefit of Japanese Patent Application No. 2023-051818, filed Mar. 28, 2023, both of which are hereby incorporated by reference herein in their entirety.

### BACKGROUND

### Field of the Technology

The present disclosure relates to an image forming apparatus that forms images on recording materials.

### Description of the Related Art

Electrophotographic image forming apparatuses of rotary developing system where a color image is formed by rotating a rotary equipped with a plurality of developing rollers have been known. Japanese Patent Laid-Open No. 2007-183305 and Japanese Patent Laid-Open No. 2008-096852 describe image forming apparatuses including a rotary equipped with a plurality of developing rollers and a plurality of toner cartridges (toner accommodation containers) each detachably mountable to the rotary.

### SUMMARY

The present disclosure is directed to providing a new form of image forming apparatus that is an advancement of the conventional techniques.

An aspect of the present disclosure is as follows:

An image forming apparatus to which a cartridge accommodating a developer is detachably mountable includes a rotary configured to be rotatable about a rotation axis extending in an axial direction, the rotary including a developing chamber configured to accommodate the developer supplied from the cartridge, and a tray capable of detachably supporting the cartridge so that the cartridge assumes a first orientation, the tray including a first opposed portion configured to be opposed to the cartridge in the first orientation and extend in a predetermined direction, the tray being configured to be displaced relative to the rotary to a first position where the cartridge supported in the first orientation is located outside the rotary and a second position where the cartridge supported in the first orientation is located inside the rotary, wherein a detachment direction is a direction in which the cartridge supported by the tray in the first orientation is detached from the tray, wherein the predetermined direction is a direction orthogonal to the detachment direction, and wherein with the cartridge in the first orientation, a part of the cartridge is located downstream, in the predetermined direction, of a downstream end of the first opposed portion in the predetermined direction.

Features of the present disclosure will become apparent from the following description of embodiments with reference to the attached drawings.

### BRIEF DESCRIPTION OF THE DRAWINGS

FIG. 1 is a schematic diagram illustrating an image forming apparatus according to a first embodiment.

FIG. 2 is a configuration diagram of the image forming apparatus according to the first embodiment.

FIG. 3 is a schematic diagram illustrating a developing unit, a toner cartridge, and a tray according to the first embodiment.

FIG. 4A is a sectional view of the image forming apparatus according to the first embodiment.

FIG. 4B is a sectional view of the image forming apparatus according to the first embodiment.

FIG. 5 is a perspective view of a rotary main body according to the first embodiment.

FIG. 6A is a perspective view of the image forming apparatus according to the first embodiment.

FIG. 6B is a perspective view of the image forming apparatus according to the first embodiment.

FIG. 6C is a perspective view of the image forming apparatus according to the first embodiment.

FIG. 7A is a sectional view of the image forming apparatus according to the first embodiment.

FIG. 7B is a sectional view of the image forming apparatus according to the first embodiment.

FIG. 8 is an explanatory diagram illustrating the rotary main body according to the first embodiment.

FIG. 9 is an explanatory diagram illustrating the rotary main body according to the first embodiment.

FIG. 10 is an explanatory diagram illustrating the rotary main body according to the first embodiment.

FIG. 11A is an explanatory diagram illustrating a configuration related to tray movement according to the first embodiment.

FIG. 11B is an explanatory diagram illustrating the configuration related to tray movement according to the first embodiment.

FIG. 12A is an explanatory diagram illustrating the configuration related to tray movement according to the first embodiment.

FIG. 12B is an explanatory diagram illustrating the configuration related to tray movement according to the first embodiment.

FIG. 13 is a perspective view of a tray according to the first embodiment.

FIG. 14 is a plan view of trays according to the first embodiment.

FIG. 15 is a perspective view of a toner cartridge according to the first embodiment.

FIG. 16 is a perspective view of a toner cartridge according to the first embodiment.

FIG. 17 is a bottom plan view of toner cartridges according to the first embodiment.

FIG. 18 is a diagram illustrating a state before a toner cartridge is mounted on a tray according to the first embodiment.

FIG. 19A is a perspective view of normal mounting according to the first embodiment.

FIG. 19B is a perspective view of erroneous mounting according to the first embodiment.

FIG. 20A is a plan view illustrating a state of erroneous mounting according to the first embodiment.

FIG. 20B is a plan view illustrating a state of erroneous mounting according to the first embodiment.

FIG. 21 is a plan view of toner cartridges according to a modification.

FIG. 22 is a plan view of trays according to the modification.

FIG. 23 is a plan view of trays according to a modification.

FIG. 24 is a plan view of toner cartridges according to the modification.

FIG. 25 is a perspective view of the image forming apparatus where a toner cartridge is erroneously mounted, according to the first embodiment.

FIG. 26 is a perspective view of the image forming apparatus where a toner cartridge is erroneously mounted, according to the first embodiment.

FIG. 27 is a perspective view illustrating indicators of the toner cartridges and trays according to the first embodiment.

FIG. 28 is an explanatory diagram illustrating the closeness of hues of the toner cartridges and trays according to the first embodiment.

FIG. 29 is an explanatory diagram illustrating the color range of a toner cartridge and a tray 80 according to the first embodiment.

FIG. 30A is a perspective view illustrating the shape of a tray according to the first embodiment.

FIG. 30B is a plan view illustrating the shape of the tray according to the first embodiment.

FIG. 31 is a perspective view of the tray and toner cartridge according to the first embodiment.

FIG. 32 is a plan view of the tray and toner cartridge according to the first embodiment.

FIG. 33A is a perspective view of a tray according to a modification.

FIG. 33B is a plan view of the tray and toner cartridge according to the modification.

FIG. 34A is a perspective view of a tray according to a modification.

FIG. 34B is a schematic diagram of the tray and toner cartridge according to the modification.

FIG. 34C is a schematic diagram of the tray and toner cartridge according to the modification.

FIG. 35 is a perspective view of a tray according to a modification.

FIG. 36A is a perspective view of a tray according to a modification.

FIG. 36B is a schematic diagram of the tray and toner cartridge according to the modification.

FIG. 37 is a schematic diagram of a tray and a toner cartridge according to a modification.

### DESCRIPTION OF THE EMBODIMENTS

Embodiments of the present disclosure will be described below with reference to the drawings.

### First Embodiment

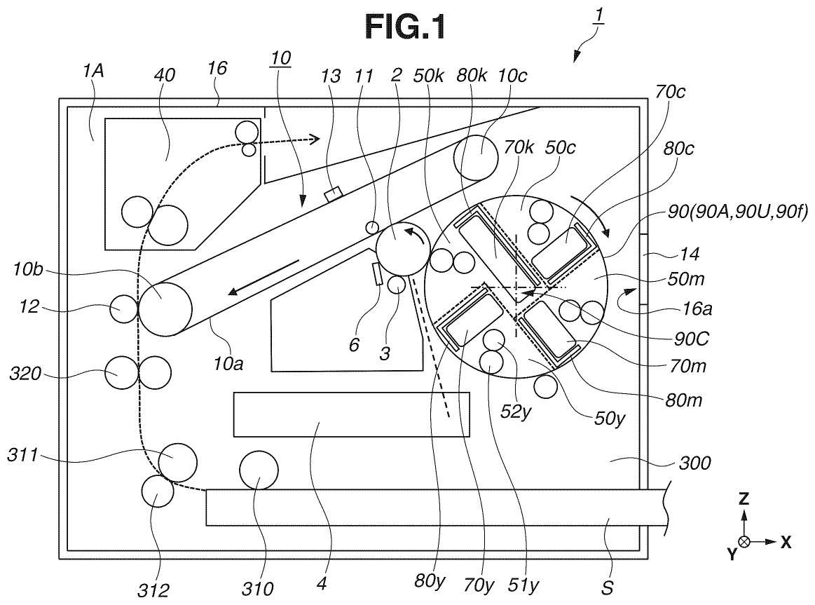

An image forming apparatus 1 according to a first embodiment will be described with reference to FIGS. 1 to 12B. In the following description and drawings, a vertical direction when the image forming apparatus 1 is installed on a horizontal plane will be referred to as a Z direction. A direction that intersects the Z direction and is along the direction of a rotation axis 90C of a rotary main body 90 to be described below (rotation axis direction of a rotary) will be referred to as a Y direction. A direction intersecting both the Z and Y directions will be referred to as an X direction. The X and Y directions are desirably horizontal directions. The X, Y, and Z directions are desirably orthogonal to each other. The directions of the arrows X, Y, and Z illustrated in the drawings are referred to as a +X side, a +Y side, and a +Z side, respectively, and the opposite sides as a −X side, a −Y side, and a −Z side, respectively, where needed.

### (Overall Configuration of Image Forming Apparatus)

An overall configuration of the image forming apparatus 1 will initially be described. The image forming apparatus 1 is a laser beam printer that electrophotographically forms images on sheets S. More specifically, the image forming apparatus 1 is a color laser beam printer including four developing units 50y, 50m, 50c, and 50k. As the sheets S, which are recording materials (recording media), various sheet materials of different sizes and substances can be used, including paper such as plain paper and thick paper, plastic films, fabric, surface-treated sheet materials such as coated paper, and sheet materials of special shapes such as envelopes and index paper.

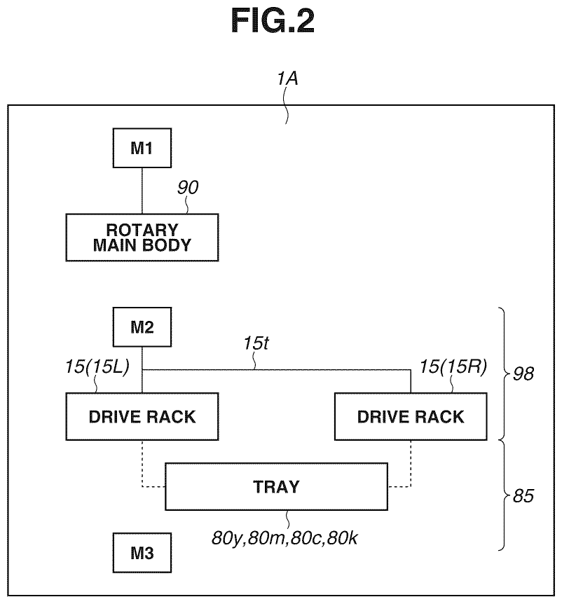

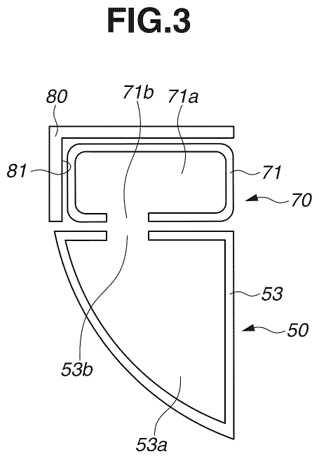

A schematic configuration and image forming operation of the image forming apparatus 1 will be described with reference to FIGS. 1, 2, and 3. FIG. 1 is a schematic diagram illustrating a sectional configuration of the image forming apparatus 1. FIG. 2 is a diagram for describing driving sources of the image forming apparatus 1. FIG. 3 is a conceptual diagram illustrating a configuration for replenishing a developing unit 50 with toner from a toner cartridge 70.

As illustrated in FIG. 1, the image forming apparatus 1 includes an image forming apparatus main body (hereinafter, apparatus main body) 1A and toner cartridges 70y, 70m, 70c, and 70k detachably mountable to the apparatus main body 1A. The apparatus main body 1A according to the present embodiment refers to the image forming apparatus 1 excluding the toner cartridges 70y, 70m, 70c, and 70k.

The apparatus main body 1A of the image forming apparatus 1 includes an electrophotographic photosensitive member (hereinafter, photosensitive drum) 2 of drum shape (cylindrical shape) as an image bearing member for bearing an electrostatic latent image. A charging roller 3, a scanner 4 serving as an exposure device, and a cleaning unit 6 are located near the photosensitive drum 2.

The charging roller 3 is an example of a charging unit for uniformly charging the photosensitive drum 2. The scanner 4 is an example of an exposure unit that irradiates the photosensitive drum 2 with laser light based on image information to perform exposure. The irradiation of the charged photosensitive drum 2 with the laser light forms an electrostatic latent image on the surface of the photosensitive drum 2. The cleaning unit 6 is an example of a cleaning unit that removes toner remaining on the surface of the photosensitive drum 2.

The apparatus main body 1A further includes a sheet accommodation unit 300, a pickup roller 310, a feed roller 311, a separation roller 312, a conveyance roller pair 320, a secondary transfer roller 12, a fixing device 40, and an intermediate transfer unit 10. The pickup roller 310 is an example of a feed unit that feeds sheets S. The feed roller 311 and the separation roller 312 are an example of a separation conveyance unit that conveys the sheets S while separating the sheets S one by one with frictional force. The secondary transfer roller 12 is an example of a transfer unit that transfers an image from an intermediate transfer belt 10a to a sheet S.

The intermediate transfer unit 10 includes the intermediate transfer belt 10a, a belt driving roller 10b, a tension roller 10c, a cleaning device 13, and a primary transfer roller 11. The intermediate transfer belt 10a is an example of an intermediate transfer member that bears an image transferred (primarily transferred) from the photosensitive drum 2 and conveys the image for transfer (secondary transfer) to the sheet S. The intermediate transfer belt 10a is stretched across the belt driving roller 10b and the tension roller 10c. The belt driving roller 10b is a driving member that is driven to rotate by a driving source and thereby conveys the intermediate transfer belt 10a.

The apparatus main body 1A also includes a rotary main body (rotary, rotating body) 90 that includes the developing units 50y, 50m, 50c, and 50k. As will be described below, in the present embodiment, the rotary main body 90 is equipped with trays (support members) 80y, 80m, 80c, and 80k. The toner cartridges 70y, 70m, 70c, and 70k are detachably mounted on the trays 80y, 80m, 80c, and 80k.

In the following description, a plurality of members and the like having similar functions can be distinguished by assigning numbers thereto. For example, one of the toner cartridges 70y, 70m, 70c, and 70k may be referred to as a first toner cartridge, one of the remaining three a second toner cartridge, one of the remaining two a third toner cartridge, and the last one a fourth toner cartridge. Similarly, one of the trays 80y, 80m, 80c, and 80k may be referred to as a first tray, one of the remaining three a second tray, one of the remaining two a third tray, and the last one a fourth tray. In other words, one of the trays 80y to 80k is an example of a first support member, another of the trays 80y to 80k is an example of a second support member, yet another of the trays 80y to 80k is an example of a third support member, and the last one of the trays 80y to 80k is an example of a fourth support member. Such numberings are used merely for the convenience of description, and are in principle interchangeable as appropriate.

The developing units (first to fourth developing units) 50y, 50m, 50c, and 50k are examples of developing units that develop (visualize) an electrostatic latent image formed on the photosensitive drum 2 into a toner image using toners of respective corresponding colors. The developing units 50y, 50m, 50c, and 50k develop an electrostatic latent image formed on the photosensitive drum 2 using yellow toner, magenta toner, cyan toner, and black toner, respectively. In other words, developers are used for development, and the image forming apparatus 1 includes a first developer, a second developer, a third developer, and a fourth developer of respective different colors.

The developing unit 50y includes a developing roller 51y, a supply roller 52y, and a developing blade. The developing roller 51y is a developer bearing member that bears toner serving as a developer and rotates to supply the toner to the photosensitive drum 2. The supply roller 52y is a supply member that is located in contact with the developing roller 51y and supplies the toner to the developing roller 51. The developing blade is a regulating member that regulates the thickness of the toner layer borne on the developing roller 51y. The other developing units 50m, 50c, and 50k include similar developing rollers 51m, 51c, and 51k, supply rollers 52m, 52c, and 52k, and developing blades.

The toner cartridges 70y, 70m, 70c, and 70k corresponding to the developing units 50y, 50m, 50c, and 50k are mounted to the rotary main body 90. The toner cartridges 70y, 70m, 70c, and 70k contain yellow toner, magenta toner, cyan toner, and black toner, respectively, as the toner to replenish the developing units 50y, 50m, 50c, and 50k. One of the four color toners can be referred to as a first toner, one of the remaining three color toners a second toner, one of the remaining two color toners a third toner, and the last one a fourth toner. For example, the black toner can be said to be an example of the first toner, and the magenta toner an example of the second toner. Such numberings are used merely for the convenience of description, and are in principle interchangeable as appropriate.

Here, the rotary main body 90 includes a rotary frame 90f that supports the developing units 50y, 50m, 50c, and 50k. The developing units 50y, 50m, 50c, and 50k are supported by the rotary frame 90f that is a rotatable rotation support member.

The rotary main body 90 is equipped with the trays 80y, 80m, 80c, and 80k. The combination of the rotary main body 90 and the trays 80y, 80m, 80c, and 80k can be referred to as a rotary unit 90U. In other words, the rotary unit 90U includes the rotary main body 90 and the trays 80y, 80m, 80c, and 80k.

The toner cartridges 70y to 70k are held by the trays 80y to 80k in a detachably mountable manner. As will be described below, the trays 80 y to 80k are supported to be slidable to the outside of the rotary main body 90. The combination of the rotary unit 90U and the toner cartridges 70y, 70m, 70c, and 70k can be referred to as a rotary assembly 90A. In other words, the rotary assembly 90A includes the rotary unit 90U and the toner cartridges 70y, 70m, 70c, and 70k.

As will be described below, the rotary main body 90 can rotate about the rotation axis (rotation center) 90C. The rotation axis 90C coincides with the rotation axes of the rotary frame 90f, the rotary unit 90U, and the rotary assembly 90A. The rotation axis 90C is substantially parallel to the rotation axis (rotation center) of the photosensitive drum 2.

The rotary main body 90 rotates about the rotation axis 90C and can thereby assume developing orientations where one of the developing rollers 51y, 51m, 51c, and 51k is opposed to the photosensitive drum 2. The orientation where the developing roller 51y is opposed to the photosensitive drum 2 will be referred to as a yellow developing orientation. The orientation where the developing roller 51m is opposed to the photosensitive drum 2 will be referred to as a magenta developing orientation. The orientation where the developing roller 51c is opposed to the photosensitive drum 2 will be referred to as a cyan developing orientation. The orientation where the developing roller 51k is opposed to the photosensitive drum 2 will be referred to as a black developing orientation. In other words, the rotary main body 90 can rotate about the rotation axis 90C so that the positions of the developing rollers 51y, 51m, 51c, and 51k relative to the photosensitive drum 2 change. The black developing orientation is an example of a first developing orientation where the first developing roller (developing roller 51k) is opposed to the photosensitive drum 2. The other developing orientations are examples of a second developing orientation where a second developing roller (developing rollers 51y to 51c) is opposed to the photosensitive drum 2. The yellow, magenta, cyan, and black developing orientations may be referred to as first to fourth developing orientations. Such numberings are used merely for the convenience of description, and are in principle interchangeable as appropriate.

As illustrated in FIG. 2, the apparatus main body 1A includes motors M1, M2, and M3 serving as driving sources. As will be described below, the motor M1 provides driving force for rotating the rotary main body 90 about the rotation axis 90C. In other words, the motor M1 rotates the rotary assembly 90A and the rotary unit 90U about the rotation axis 90C.

The apparatus main body 1A also includes a driving device 98 including the motor M2 and a transmission device. The transmission device includes drive racks 15L and 15R serving as driving gears to be described below, and a transmission unit 15t. The driving force of the motor M2 is transmitted to the drive racks 15L and 15R by the transmission unit 15t. In other words, the motor M2 is configured to drive the drive racks 15L and 15R, and moves the trays 80y, 80m, 80c, and 80k relative to the rotary main body 90 via the drive racks 15L and 15R.

The motor M3 drives members other than those driven by the motor M1 or the motor M2. For example, the motor M3 drives the photosensitive drum 2, the developing units 50y, 50m, 50c, and 50k, the pickup roller 310, the feed roller 311, the conveyance roller pair 320, the secondary transfer roller 12, the belt driving roller 10b, and the fixing device 40.

The members for the motors M1, M2, and M3 to drive can be changed as appropriate. Moreover, the roles of any two of the motors M1, M2, and M3 or all the three may be integrated into one motor. Alternatively, driving sources other than the motors M1, M2, and M3 may be added.

As employed herein, the suffixes y, m, c, and k attached to the developing units 50y, 50m, 50c, and 50k, the toner cartridges 70y, 70m, 70c, and 70k, the trays 80y, 80m, 80c, and 80k, and the like represent toner colors. The developing units 50y, 50m, 50c, and 50k have the same basic configuration and functions. The toner cartridges 70y, 70m, 70c, and 70k have the same basic configuration and functions. The trays 80y, 80m, 80c, and 80k have the same basic configuration and functions. When the four units, cartridges, or trays do not need to be distinguished from each other, the suffixes y, m, c, and k will therefore be omitted and the description refers to any one of the four units, cartridges, or trays. When the four units, cartridges, or trays are to be distinguished from each other, the suffixes y, m, c, and k are attached and the description refers to a specific one of the units, cartridges, or trays that corresponds to the suffix.

As illustrated in FIG. 3, the toner cartridge 70 includes a toner frame 71. The toner frame 71 includes a toner accommodation portion 71a that accommodates toner, and a discharge opening 71b that communicates with the toner accommodation portion 71a.

The developing unit 50 includes a developing frame (accommodation frame) 53. The developing frame 53 includes a developing accommodation portion 53a and a reception opening 53b that communicates with the developing accommodation portion (toner supply chamber) 53a. Specifically, the rotary main body 90 includes an accommodation frame 53y, an accommodation frame 53m, an accommodation frame 53c, and an accommodation frame 53k. In other words, the rotary main body 90 includes a first developing chamber, a second developing chamber, a third developing chamber, and a fourth developing chamber. As described above, the developing unit 50 includes the developing roller 51 and the supply roller 52, which are omitted in FIG. 3.

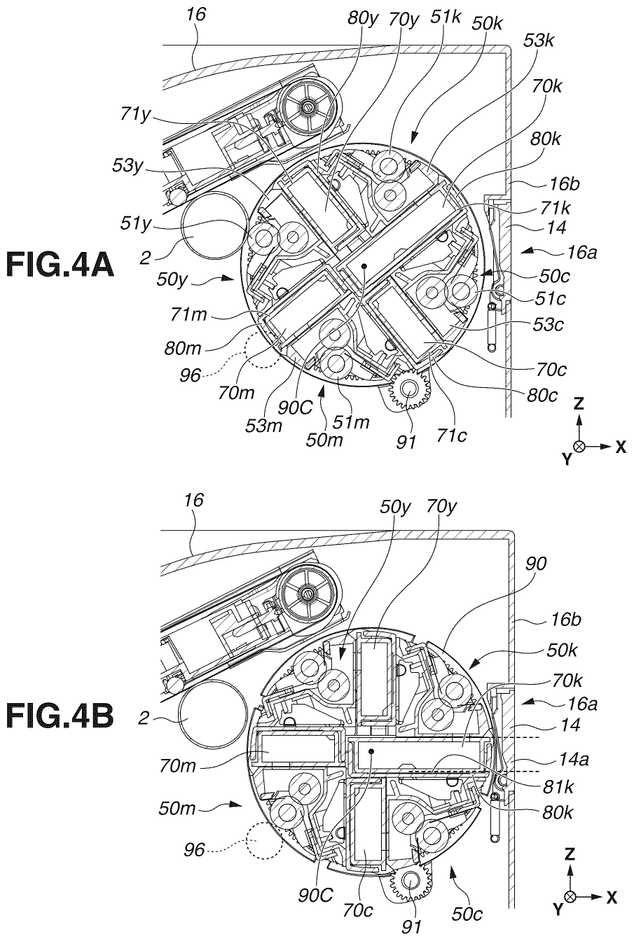

The developing roller 51k included in the developing unit 50k is an example of the first developing roller. The developing roller 51m included in the developing unit 50m is an example of the second developing roller. The developing frame 53k (FIG. 4A) of the developing unit 50k including the developing accommodation portion 53a is an example of a first accommodation frame including a first accommodation portion. The developing frame 53m (FIG. 4A) of the developing unit 50m including the developing accommodation portion 53a is an example of a second accommodation frame including a second accommodation portion. The rotary main body 90 is an example of a rotatable rotary that includes the first developing roller, the second developing roller, the first accommodation frame including the first accommodation portion, and the second accommodation frame including the second accommodation portion. In the present embodiment, the rotary main body 90 includes first to fourth developing rollers and first to fourth accommodation frames.

As will be described below, the toner cartridge 70 can move to a mounted position and a retracted position retracted from the mounted position relative to the developing frame 53. With the toner cartridge 70 at the mounted position relative to the developing frame 53, the discharge opening 71b is opposed to the reception opening 53b. In other words, the toner accommodation portion 71a of the toner cartridge 70 and the developing accommodation portion 53a of the developing unit 50 communicate via the discharge opening 71b and the reception opening 53b. In replenishing the developing unit 50 with toner from the toner cartridge 70, at least a part of the reception opening 53b is located below at least a part of the discharge opening 71b.

The toner accommodated in the toner accommodation portion 71a is then discharged from the discharge opening 71b, and the toner discharged from the discharge opening 71b is accommodated into the developing accommodation portion 53a via the reception opening 53b. Specifically, the first developer is supplied to the first developing chamber included in the rotary main body 90, the second developer is supplied to the second developing chamber, the third developer is supplied to the third developing chamber, and the fourth developer is supplied to the fourth developing chamber.

The toner accommodated in the developing accommodation portion 53a is supplied to the developing roller 51 by the supply roller 52. By such a route, the toner accommodated in the toner accommodation portion 71a is supplied to the developing roller 51.

The toner cartridge 70 desirably includes a non-illustrated sealing member (first sealing member) that covers the discharge opening 71b. Moreover, the developing unit 50 desirably includes a non-illustrated sealing member (second sealing member) that covers the reception opening 53b.

With the toner cartridge 70 not mounted to the developing unit 50, both the discharge opening 71b and the reception opening 53b are desirably covered by the sealing members so that the toner is prevented from flowing out from the discharge opening 71b or the reception opening 53b.

### (Image Forming Operation)

The image forming operation according to the present embodiment will be described. Initially, the photosensitive drum 2 is rotated in the direction of the arrow in FIG. 1 (counterclockwise) in synchronization with the rotation of the intermediate transfer belt 10a. The surface of the photosensitive drum 2 is then uniformly charged by the charging roller 3.

In forming a color image on a sheet S, the rotary main body 90 rotates in the direction of the arrow in FIG. 1 (clockwise) as will be described below while supporting the developing units 50y, 50m, 50c, and 50k. Electrophotographic processes are then repeated with the developing rollers 51y, 51m, 51c, and 51k moved to a developing position one by one.

Initially, the scanner 4 emits laser light based on image data corresponding to a yellow image, whereby an electrostatic latent image corresponding to the yellow image is formed on the surface of the photosensitive drum 2. In parallel with the formation of the electrostatic latent image, the motor M1 rotates the rotary main body 90 so that the rotary main body 90 assumes the yellow developing orientation. With the rotary main body 90 in the yellow developing orientation, the developing roller 51y is located at the developing position and develops the electrostatic latent image formed on the photosensitive drum 2 with yellow toner.

In the present embodiment, each of the developing rollers 51y, 51m, 51c, and 51k is an elastic roller including a metal core coated with rubber. At the developing position, each of the developing rollers 51y, 51m, 51c, and 51k develops the electrostatic latent image in contact with the photosensitive drum 2. In other words, the image forming apparatus 1 according to the present embodiment employs a contact developing method. However, at the developing position, each of the developing rollers 51y, 51m, 51c, and 51k may develop the electrostatic latent image with a gap between the developing roller and the photosensitive drum 2. In other words, the image forming apparatus 1 may employ a non-contact developing method.

Once the yellow toner image is developed, the yellow toner image on the photosensitive drum 2 is primarily transferred to the intermediate transfer belt 10a by the primary transfer roller 11 located inside the intermediate transfer belt 10a.

Subsequently, the rotary main body 90 is rotated to move the developing rollers 51m, 51c, and 51k to the developing position in order, whereby respective color toner images are formed. More specifically, after the formation of the yellow toner image on the intermediate transfer belt 10a, the rotary main body 90 assumes the magenta developing orientation and a magenta toner image is formed on the intermediate transfer belt 10a. After the formation of the magenta toner image on the intermediate transfer belt 10a, the rotary main body 90 assumes the cyan developing orientation and a cyan toner image is formed on the intermediate transfer belt 10a. After the formation of the cyan toner image on the intermediate transfer belt 10a, the rotary main body 90 assumes the black developing orientation and a black toner image is formed on the intermediate transfer belt 10a.

A color image is formed on the intermediate transfer belt 10a by repeating the primary transfer so that the four color toner images are superposed on the intermediate transfer belt 10a. Note that until the color image is formed on the intermediate transfer belt 10a, the secondary transfer roller 12 and the cleaning device 13 are not in contact with the intermediate transfer belt 10a.

Meanwhile, sheets S are fed from the sheet accommodation unit 300 located in the lower part of the apparatus main body 1A by the pickup roller 310. The sheets S are separated one by one by the feed roller 311 and the separation roller 312, and fed to the conveyance roller pair 320. The conveyance roller pair 320 sends out the fed sheet S to a transfer portion (secondary transfer portion) that is the nip portion between the intermediate transfer belt 10a and the secondary transfer roller 12. The color image on the intermediate transfer belt 10a is transferred (secondarily transferred) to the surface of the conveyed sheet S.

The sheet S to which the color image is transferred is sent to the fixing device 40. In the fixing device 40, the sheet S is heated and pressed, whereby the image is fixed to the sheet S. The sheet S having passed through the fixing device 40 is discharged to the outside of the image forming apparatus 1 as a product.

Now, in forming a monochrome image on a sheet S, the rotary main body 90 assumes the black developing orientation. In such a state, the photosensitive drum 2 is charged and exposed to form an electrostatic latent image on the surface of the photosensitive drum 2, and then the electrostatic latent image is developed with black toner by the developing roller 51k located at the developing position. The black toner image is primarily transferred to the intermediate transfer belt 10a and then secondarily transferred to the sheet S. The subsequent processes are similar to those for a color image.

### (Rotary Configuration)

A configuration of the rotary main body 90 will be described with reference to FIGS. 1, 4A, 4B, and 5.

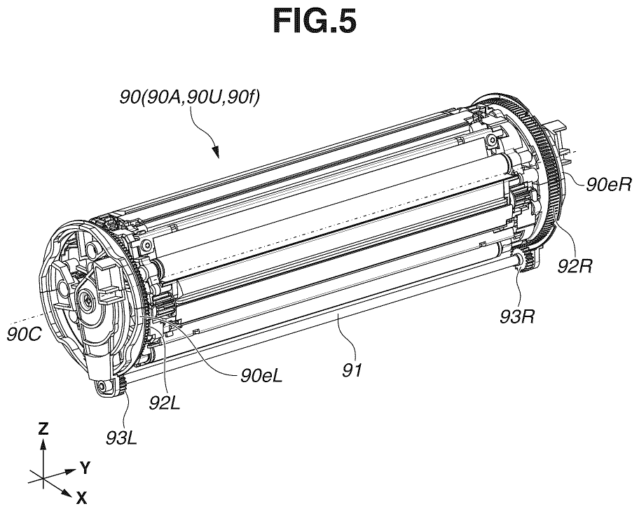

FIGS. 4A and 4B are sectional views illustrating the rotary main body 90 of the image forming apparatus 1 and its vicinity. FIGS. 4A and 4B are sectional views of the apparatus, taken along an imaginary plane perpendicular to the rotation axis 90C of the rotary main body 90. FIG. 5 is a perspective view of the rotary main body 90.

As described above, the toner cartridges 70y to 70k can be mounted to and detached from the rotary main body 90. When the toner cartridges 70y to 70m run out of toner, the user can replace the toner cartridges 70y to 70k to replenish the image forming apparatus 1 with toner.

As illustrated in FIG. 1, the apparatus main body 1A includes a frame 16 that accommodates the rotary main body 90.

The frame 16 is a main body frame of the image forming apparatus 1 according to the present embodiment. The frame 16 is a housing (body structure) of the apparatus main body 1A constituted by frames and exterior members. In the present embodiment, the frame 16 has a substantially rectangular parallelopiped shape.

The frame 16 has an opening 16a. More specifically, the frame 16 includes a side surface 16b extending in a direction intersecting the horizontal directions. The side surface 16b constitutes at least a part of an exterior surface of the apparatus main body 1A on the +X side. The opening 16a is disposed in this side surface 16b. The side surface 16b is one located downstream of a discharge port of the apparatus main body 1A in a discharge direction in which image-formed sheets S are discharged from the discharge port. The user can access the sheet accommodation unit 300 to replenish sheets S or retrieve the sheets S discharged from the discharge port from the side surface 16b-side of the image forming apparatus 1. The side surface 16b can thus be said to be the front (front surface) of the apparatus main body 1A.

The toner cartridges 70y, 70m, 70c, and 70k can be mounted to and detached from the rotary main body 90 through the opening 16a. In other words, the toner cartridge 70k can be said to be an example of the first toner cartridge that accommodates the toner to be supplied to the first developing roller (developing roller 51k) and can be mounted to and detached from the rotary (rotary main body 90) through the opening 16a in the frame 16 of the apparatus main body 1A. The toner cartridge 70m can be said to be an example of the second toner cartridge that accommodates the toner to be supplied to the second developing roller (developing roller 51m) and can be mounted to and detached from the rotary (rotary main body 90) through the opening 16a in the frame 16 of the apparatus main body 1A.

In the present embodiment, the toner cartridges 70y, 70m, 70c, and 70k are mounted to and detached from the rotary main body 90 through the opening 16a as supported by the trays 80y to 80k. In other words, the user can mount and detach the toner cartridges 70y to 70k to/from the rotary main body 90 via the trays 80y to 80k.

The opening 16a is disposed in the side surface 16b of the frame 16. In the present embodiment, the side surface 16b is a surface substantially parallel to the rotation axis 90C of the rotary main body 90. In replacing a toner cartridge 70, the toner cartridge 70 therefore passes through the opening 16a in a direction intersecting (desirably, a direction orthogonal to) the rotation axis 90C.

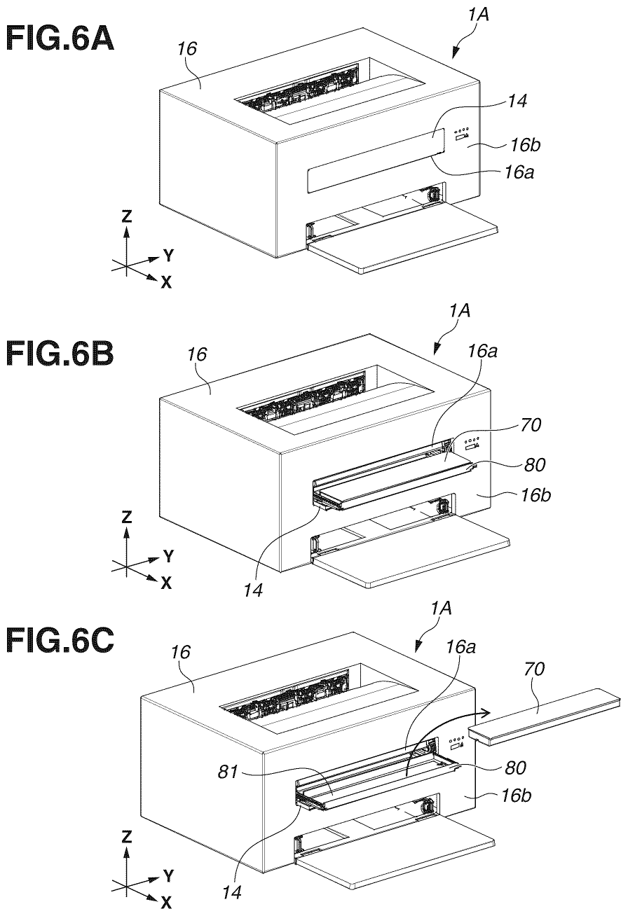

The image forming apparatus 1 includes a door 14 that covers the opening 16a of the frame 16. The door 14 is an opening/closing member that can move to a closed position to cover the opening 16a (see also FIG. 6A) and an open position to expose the opening 16a (see also FIGS. 6B and 6C).

As described above, in the present embodiment, the toner cartridge 70 is configured to be detachably mountable to the rotary main body 90 via the tray 80. The toner cartridge 70 can thus be stably mounted to and detached from the rotary main body 90.

More specifically, the user can replace the toner cartridge 70 by the operation of mounting and detaching the toner cartridge 70 on/from the tray 80 that is configured to be movable relative to the rotary main body 90 (i.e., relative to the apparatus main body 1A). In a configuration where the user replaces the toner cartridge by directly inserting and removing the toner cartridge into/from the apparatus main body, the user needs to insert the toner cartridge up to a predetermined mounted position in the apparatus main body. In the present embodiment, the tray 80 with the toner cartridge 70 supported thereon can move so that the toner cartridge 70 moves to the mounted position. The user can thus replace the toner cartridge 70 by a simple operation of placing the toner cartridge 70 on the tray 80, with improved operability.

The toner cartridge 70 has a slender elongated shape with the Y direction parallel to the rotation axis 90C of the rotary main body 90 as its longitudinal direction. In other words, the longitudinal dimension of the toner cartridge 70 is greater than its height and width in a cross section orthogonal to the longitudinal direction. In the case of handling such an elongated toner cartridge 70, the disposition of the opening 16a in the side surface 16b of the frame 16 substantially parallel to the longitudinal direction (Y direction) of the toner cartridge 70 enables the toner cartridge 70 to pass through the opening 16a with a short moving distance. This facilitates the replacement of the toner cartridge 70 compared to a case where the toner cartridge 70 is inserted and removed via an opening disposed in a side surface on one side (+Y side or −Y side) of the frame 16 in the longitudinal direction of the toner cartridge 70, for example.

The rotary main body 90 rotates about the rotation axis 90C and can assume replacement orientations where one of the toner cartridges 70y to 70k can be detached from the rotary main body 90. The orientation where the toner cartridge 70y can be detached will be referred to as a yellow replacement orientation. The orientation where the toner cartridge 70m can be detached will be referred to as a magenta replacement orientation. The orientation where the toner cartridge 70c can be detached will be referred to as a cyan replacement orientation.

The orientation where the toner cartridge 70k can be detached will be referred to as a black replacement orientation. The black replacement orientation is an example of a first replacement orientation where the first toner cartridge can be detached from the rotary. The yellow, magenta, and cyan replacement orientations are examples of a second replacement orientation where the second toner cartridge can be detached from the rotary. The yellow, magenta, cyan, and black replacement orientations may be referred to as first to fourth replacement orientations. Such numberings are used merely for the convenience of description, and are in principle interchangeable as appropriate.

FIG. 4A illustrates a cross section of the rotary main body 90 assuming a developing orientation (specifically, yellow developing orientation). FIG. 4B illustrates a cross section of the rotary main body 90 assuming a replacement orientation (specifically, black replacement orientation).

As illustrated in FIGS. 4A and 4B, the four trays 80y to 80k are mounted to the rotary main body 90. The trays 80y to 80k hold the toner cartridges 70y to 70k, respectively. In FIGS. 4A and 4B, the trays 80y to 80k are accommodated inside the rotary main body 90, in which state the toner cartridges 70y to 70k can be said to be mounted on the developing units 50y, 50m, 50c, and 50k.

As described above, the toner cartridge 70 can be moved to the mounted position and the retracted position retracted from the mounted position relative to the developing frame 53 of the developing unit 50. More specifically, the first toner cartridge (toner cartridge 70k) can be moved to a first mounted position and a first retracted position relative to the first accommodation frame (developing frame 53k). The second toner cartridge (toner cartridge 70m) can be moved to a second mounted position and a second retracted position relative to the second accommodation frame (developing frame 53m).

With the toner cartridge 70 at the mounted position relative to the developing frame 53, as illustrated in FIG. 3, the discharge opening 71b and the reception opening 53b are opposed to each other. The toner cartridge 70 is configured to supply the toner to the developing accommodation portion 53a through the reception opening 53b (opening of the accommodation frame) in such a state.

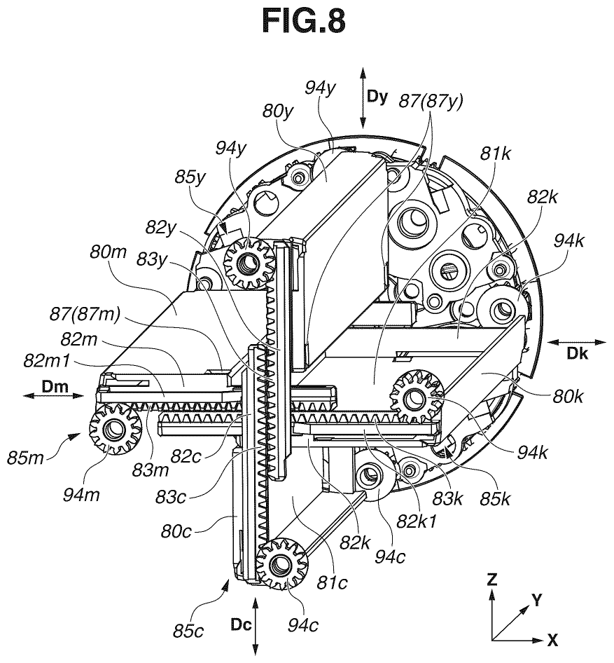

The apparatus main body 1A includes a moving device 85 configured to move the toner cartridge 70 from the mounted position to the retracted position relative to the rotary main body 90 (more specifically, relative to the developing frame 53 of the developing unit 50). The moving device 85 will be described below with reference to FIG. 8 and the like. In the present embodiment, the rotary main body 90 includes a plurality of moving devices 85y to 85k corresponding to the plurality of toner cartridges 70y to 70k. The trays 80y to 80k can be said to be a part of the moving devices 85y to 85k.

In the present embodiment, the toner cartridge 70k accommodating black toner is larger in size and can accommodate more toner than the toner cartridges 70y to 70c accommodating yellow, magenta, and cyan toners. In other words, the first toner cartridge can accommodate a first amount of toner, the second toner cartridge can accommodate a second amount of toner, and the first amount can be said to be greater than the second amount.

Specifically, the length of the black toner cartridge 70k in a first radial direction relative to the rotation axis 90C of the rotary main body 90 is greater than the length of the magenta toner cartridge 70m in a second radial direction. As employed herein, the first radial direction refers to a radial direction of rotation of the rotary main body 90 (radial direction of an imaginary circle about the rotation axis 90C), the direction in which the toner cartridge 70k extends relative to the rotation axis 90C as viewed in the direction of the rotation axis 90C. The second radial direction refers to a radial direction of rotation of the rotary main body 90, the direction in which the toner cartridge 70m extends relative to the rotation axis 90C as viewed in the direction of the rotation axis 90C. Similarly, the length of the black toner cartridge 70k in the first radial direction is greater than those of the other toner cartridges 70y and 70c in radial directions corresponding to the toner cartridges 70y and 70c.

The tray 80k holding the black toner cartridge 70k is thus larger in size than the trays 80y to 80c holding the other toner cartridges 70y, 70m, and 70c. That is, the rotary main body 90 includes the four toner cartridges 70y to 70k and trays 80y to 80k of different sizes. In other words, the toner cartridge 70k as an example of the first toner cartridge and the toner cartridge 70y as an example of the second toner cartridge smaller in size than the first toner cartridge can be mounted to and detached from the rotary main body 90. The rotary main body 90 accordingly includes the tray 80k as an example of the first support member supporting the first toner cartridge and the tray 80y as an example of the second support member smaller in size than the first support member. Moreover, the toner cartridges 70m and 70c as an example of the third toner cartridge and fourth toner cartridge smaller in size than the first toner cartridge can be mounted to and detached from the rotary main body 90. The main body 90 accordingly includes the trays 80m and 80c as an example of the third support member and fourth support member smaller in size than the first support member.

Now, rotational driving of the rotary main body 90 will be described with reference to FIG. 5. As illustrated in FIG. 5, disk gears 92L and 92R are formed at both ends of the rotary main body 90. Moreover, rotary drive gears 93L and 93R are coupled to both ends of a swing shaft 91 in a manner capable of drive transmission. Here, the driving force of the motor M1 is transmitted to the rotary drive gear 93R by a drive transmission mechanism. The driving force is then transmitted to the disk gears 92L and 92R by the rotary drive gears 93L and 93R, whereby the rotary main body 90 is driven to rotate.

The rotary main body 90 is swingably supported about the swing shaft 91. The rotary main body 90 is biased about the swing shaft 91 counterclockwise in FIGS. 4A and 4B by a non-illustrated biasing member. This direction can be said to be a direction in which each of the developing rollers 51y to 51k approaches the photosensitive drum 2. As a result, with the rotary main body 90 assuming the developing orientations, each of the developing rollers 51y to 51k is in contact with the photosensitive drum 2.

As illustrated in FIG. 5, the rotary main body 90 includes rotary cams 90eL and 90eR at both ends. When the rotary main body 90 rotates about the rotation axis 90C clockwise in FIGS. 4A and 4B, the rotary cams 90eL and 90eR come into contact with a roller 96 supported by the frame 16 (FIGS. 4A and 4B). The rotary main body 90 then moves about the swing shaft 91 clockwise in FIGS. 4A and 4B. This direction can be said to be a direction in which each of the developing rollers 51y to 51k gets away from the photosensitive drum 2. This direction can also be said to be a direction in which the rotary main body 90 approaches the opening 16a of the frame 16 and the door 14.

Consequently, when the rotary main body 90 rotates and switches from a developing orientation to a replacement orientation, the rotary main body 90 swings about the swing shaft 91. With the rotary main body 90 in a replacement orientation, the developing roller 51 is separated from the photosensitive drum 2.

As illustrated in FIG. 4B, in the black replacement orientation, the toner cartridge 70k stops at a position opposed to the opening 16a disposed in the side surface 16b of the apparatus main body 1A and the door 14. When in such a state the tray 80k is slid from the mounted position relative to the developing unit 50k to the outside of the rotary main body 90, the user can replace the toner cartridge 70k.

### (Toner Cartridge Replacement Operation)

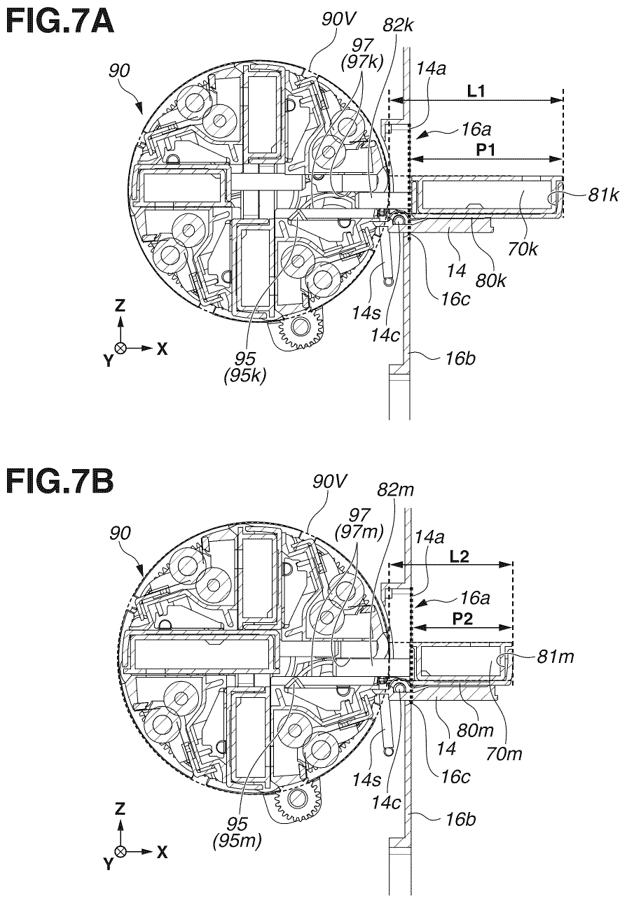

A toner cartridge replacement operation will be described with reference to FIGS. 4A, 6A to 6C, 7A, and 7B. FIGS. 6A to 6C are external views of the apparatus main body 1A. FIGS. 7A and 7B are sectional views of the vicinity of the rotary main body 90 during toner cartridge replacement. FIGS. 7A and 7B are sectional views of the apparatus, taken along an imaginary plane perpendicular to the rotation axis 90C of the rotary main body 90.

FIG. 6A illustrates the appearance of the apparatus main body 1A during image forming operation and in a standby state. During image forming operation refers to the execution period of a series of operations in which the image forming apparatus 1 feeds a sheet S, forms an image on the sheet S, and then discharges the sheet S as a product. The standby state refers to a state where the image forming apparatus 1 can start image formation operation upon reception of image forming instructions (print instructions) and is waiting for image forming instructions from the user. As illustrated in FIG. 6A, the door 14 is closed during image formation operation and in the standby state.

FIG. 6B illustrates the appearance of the apparatus main body 1A during toner cartridge replacement. During toner cartridge replacement, the door 14 is opened, and the tray 80 and the toner cartridge 70 are moved to the outside of the apparatus main body 1A.

The toner cartridge 70 can be moved to the mounted position and the retracted position retracted from the mounted position relative to the developing frame 53 of the developing unit 50. With the toner cartridge 70 at the mounted position relative to the developing frame 53, as illustrated in FIG. 3, the discharge opening 71b and the reception opening 53b are opposed to each other. As illustrated in FIGS. 4A and 4B, the rotary main body 90 is configured to rotate about the rotation axis 90C and assume the developing orientations and replacement orientations with the toner cartridge 70 at the mounted position.

The toner cartridge replacement operation will be described. Initially, the user instructs a control unit of the apparatus main body 1A to perform toner cartridge replacement operation. The instruction for the toner cartridge replacement operation is given, for example, through input via an operation panel (operation unit) provided on the apparatus main body 1A.

When the control unit receives the instruction for the toner cartridge replacement operation, the rotary main body 90 rotates to the replacement orientation for the toner cartridge 70 to be replaced (toner cartridge 70 that has run out of toner) and stops. In other words, the control unit rotates the rotary main body 90 to the replacement orientation for the toner cartridge specified by the instruction for the toner cartridge replacement operation (in FIG. 4B, black replacement orientation for replacing the black toner cartridge 70k). In the replacement orientation, the tray 80 supporting the toner cartridge 70 instructed to be replaced is opposed to the opening 16a in the frame 16 of the apparatus main body 1A.

For example, the rotary main body 90 of FIG. 4A is in the yellow developing orientation where the yellow developing roller 51y is opposed to the photosensitive drum 2. Here, the black toner cartridge 70k and the tray 80k do not need to be opposed to the opening 16a or the door 14. In other words, the toner cartridge 70 and tray 80 do not need to be opposed to the opening 16a or the door 14 when the rotary main body 90 is in a replacement orientation other than for that toner cartridge or in a developing orientation. The opening 16a therefore only need to have a size that allows each toner cartridge 70 to pass through singly. When the rotary main body 90 rotates from the yellow developing orientation by a predetermined angle clockwise in the diagram, the black toner cartridge 70k and tray 80k are opposed to the opening 16a and the door 14 as illustrated in FIG. 4B.

As employed herein, “a tray 80 is opposed to the opening 16a” means that the tray 80 is located so that it can be moved to the outside of the apparatus main body 1A via the opening 16a. In other words, when the tray 80 is opposed to the opening 16a, the tray 80 and the toner cartridge 70 supported by the tray 80 can be protruded to the outside of the apparatus main body 1A by the tray 80 being moved outward in the radial direction of rotation of the rotary main body 90 by a moving mechanism to be described below. In FIG. 4A, none of the trays 80y to 80k is opposed to the opening 16a. In FIG. 4B, only the black tray 80k is opposed to the opening 16a and the other trays 80y to 80c are not opposed to the opening 16a.

When the rotary main body 90 is positioned to a replacement orientation, the motor M2 moves the tray 80 supporting the toner cartridge 70 to be replaced toward the outside of the apparatus main body 1A.

As a result, the toner cartridge 70 to be replaced moves from the mounted position to the retracted position relative to the rotary main body 90. As illustrated in FIGS. 6B, 6C, 7A, and 7B, the tray 80 and the toner cartridge 70 to be replaced supported by the tray 80 protrude outside the apparatus main body 1A via the opening 16a.

More specifically, the tray 80 can be moved to an accommodation position and a detachment position relative to the rotary main body 90. In other words, the first tray can be moved to an accommodation position (second position) and a detachment position (first position) relative to the rotary main body 90. The second tray can be moved to an accommodation position (fourth position) and a detachment position (third position) relative to the rotary main body 90. The accommodation position refers to the position where the tray 80 is accommodated inside the rotary main body 90. The detachment position refers to the position (detachment position, replaceable position) where the tray 80 protrudes outside the rotary main body 90 and the toner cartridge 70 can be detached from the tray 80. Examples of the accommodation position include the positions of the trays 80y to 80k in FIGS. 4A and 4B. Examples of the detachment position include the positions of the tray 80 in FIGS. 6B and 6C, the tray 80k in FIG. 7A, and the tray 80m in FIG. 7B.

When the tray 80 is at the accommodation position, the toner cartridge 70 mounted on the tray 80 is located inside the rotary main body 90 and at the mounted position. When the tray 80 is at the detachment position, the toner cartridge 70 mounted on the tray 80 is located outside the rotary main body 90 and at the retracted position.

As illustrated in FIGS. 7A and 7B, the rotary main body 90 includes a protrusion 95 for holding the tray 80 at the accommodation position and holding the toner cartridge 70 at the mounted position. As illustrated in FIG. 8, the tray 80 has a recess 87 for the protrusion 95 to fit. While FIGS. 7A and 7B illustrate protrusions 95k and 95m corresponding to the trays 80k and 80m, and FIG. 8 illustrates recesses 87y and 87m corresponding to the trays 80y and 80m, the protrusion 95 and recess 87 are provided for each of the trays 80y to 80k. The protrusion 95 is desirably biased in a direction of engaging with the recess 87.

The fitting of the protrusion 95 to the recess 87 of the tray 80 locks the tray 80 relative to the rotary frame 90f. This retains the tray 80 at the accommodation position and prevents the toner cartridge 70 from moving from the mounted position even when the rotary main body 90 rotates. The protrusion 95 can be configured so that when the tray 80 is moved between the accommodation position and the detachment position by the moving device to be described below, the protrusion 95 is moved by the tray 80 and disengaged from the recess 87.

In the present embodiment, the door 14 is supported to be rotatable relative to the apparatus main body 1A. As illustrated in FIG. 7A, the door 14 is biased from the open position toward the closed position by a spring 14s. The spring 14s is a tension spring, for example, and biases the door 14 to generate a counterclockwise moment in FIGS. 7A and 7B about a spindle 14c of the door 14.

The door 14 is brought into an open state (the state of FIG. 6B) by the tray 80 pushing the door 14. This state can also be said to be a state where the tray 80 is supported by the door 14. Since the door 14 supports at least a part of the tray 80 protruding outside the apparatus main body 1A, the toner cartridge 70 can be more stably supported. In other words, when the first toner cartridge (toner cartridge 70k) is at the first retracted position, the opening/closing member (door 14) at the open position supports the first support member (tray 80k). When the second toner cartridge (toner cartridges 70y to 70c) is at the second retracted position, the opening/closing member (door 14) at the open position supports the second support member (trays 80y to 80c).

The door 14 is configured to contact a part of the frame 16 of the apparatus main body 1A (for example, a lower edge 16c of the opening 16a) at the open position and not rotate downward beyond the open position. When the tray 80 is withdrawn from outside to inside the apparatus main body 1A, the door 14 returns to the closed position due to the biasing force of the spring 14s.

The toner cartridge 70 is held by the tray 80 in a detachably mountable manner. As illustrated in FIG. 6C, the user can thus perform an operation of dismounting the toner cartridge 70 from the tray 80 and mounting a new toner cartridge 70 (replacement operation). In replacing the plurality of toner cartridges 70, the replacement operation can be performed by repeating the foregoing operations.

FIGS. 7A and 7B illustrate cross sections of the vicinity of the rotary main body 90 during toner cartridge replacement. FIG. 7A illustrates a state during replacement of the black toner cartridge 70k. FIG. 7B illustrates a state during replacement of the magenta toner cartridge 70m.

The image forming apparatus 1 includes the moving device 85 (FIG. 8) that moves the toner cartridge 70 from the mounted position to the retracted position. In the present embodiment, the moving device 85 can be said to include the tray 80. The moving device 85k including the tray 80k can be said to be an example of a first moving device including the first support member. The moving device 85m including the tray 80m can be said to be an example of a second moving device including the second support member.

The tray 80 remains coupled to the rotary main body 90 (supported by the rotary main body 90) even with the toner cartridge 70 at the retracted position. To facilitate the operation of detaching the toner cartridge 70 from the rotary main body 90, the protruding length of the toner cartridge 70 from the rotary main body 90 at the retracted position is desirably large. Since the toner cartridge 70 is configured to be detachably mountable to the rotary main body 90 via the tray 80, the toner cartridge 70 can be stably supported by the tray 80 even when the protruding length of the toner cartridge 70 from the rotary main body 90 is large.

The moving direction of the toner cartridge 70 when the toner cartridge 70 moves from the mounted position to the retracted position will be referred to as a retraction direction. In the present embodiment, the retraction direction of the toner cartridge 70 is a direction intersecting the direction of the rotation axis 90C (Y direction). As illustrated in FIGS. 7A and 7B, when viewed in the direction of the rotation axis 90C (Y direction), the retraction direction of the toner cartridge 70 is therefore a direction orthogonal to the direction of the rotation axis 90C (Y direction). The retraction direction of the toner cartridge 70 can be said to be an outward direction in the radial direction of rotation of the rotary main body 90 (a direction away from the rotation axis 90C).

As illustrated in FIGS. 7A and 7B, for the sake of the user's operation of detaching the toner cartridge 70 from the rotary main body 90, at least a part of the toner cartridge 70 is desirably protruded from the rotary main body 90 when the toner cartridge 70 is detached. In the present embodiment, when the toner cartridge 70 is at the retracted position, the entire toner cartridge 70 protrudes from the rotary main body 90.

When the rotary main body 90 rotates about the rotation axis 90C, the rotation path of the rotary main body 90 can be said to coincide with the circumscribed circle of the rotary main body 90 about the rotation axis 90C (imaginary circle 90V illustrated by a dotted line in FIGS. 7A and 7B). When the toner cartridge 70 is at the retracted position, half or more of the length of the toner cartridge 70 in the retraction direction desirably lies outside the rotation path of the rotary main body 90. In other words, when viewed in the rotation axis direction of the rotary, with the toner cartridge at the retracted position, half or more of the total length of the toner cartridge in the moving direction of the toner cartridge from the mounted position to the retracted position desirably lies outside the rotation path of the rotary. This applies to each of the toner cartridges 70 including the toner cartridge 70k as an example of the first cartridge and the toner cartridge 70m as an example of the second cartridge. In the present embodiment, as illustrated in FIGS. 7A and 7B, when the toner cartridge 70 is at the retracted position, the entire toner cartridge 70 is located outside the rotation path (imaginary circle 90V) of the rotary main body 90.

Moreover, to facilitate the user gripping the toner cartridge 70, at least a part of the toner cartridge 70 is desirably on the outside of the image forming apparatus 1 (outside of the apparatus main body 1A) when the toner cartridge 70 is at the retracted position. As employed herein, “the outside of the apparatus” refers to the space outside the image forming apparatus 1 (outside the apparatus main body 1A) when the image forming apparatus 1 is in use, such as during image forming operation on sheets S.

In the present embodiment, the exterior surface of the apparatus main body 1A is constituted by that of the frame 16. That is, the outside of the apparatus can be said to be outside the frame 16. The state in which at least a part of the toner cartridge 70 is on the outside of the apparatus can therefore be said to be where at least a part of the toner cartridge 70 protrudes from the opening 16a in the frame 16 of the apparatus main body 1A to the outside of the frame 16.

In the present embodiment, when the door 14 is at the closed position, the opening 16a in the frame 16 of the apparatus main body 1A is covered by the door 14. An exterior surface 14a of the door 14 at the closed position then constitutes a part of the exterior surface of the apparatus main body 1A. In such a case, the outside of the apparatus refers to outside the exterior surface 14a of the door 14 at the closed position. In other words, when the toner cartridge 70 is at the retracted position, at least a part of the toner cartridge 70 is located outside of the apparatus main body 1A relative to an exterior position, where the exterior position refers to the position of the exterior surface 14a of the door 14 at the closed position.

In other words, assuming that the door 14 is at the closed position, at least a part of the toner cartridge 70 is located in the space outside the apparatus main body 1A. At least a part of the toner cartridge 70 is then located downstream of the exterior position in the retraction direction of the toner cartridge 70.

With the side surface 16b where the opening 16a is disposed as the front of the apparatus main body 1A, when the toner cartridge 70 is at the retracted position, at least a part of the toner cartridge 70 can be said to protrude forward from the front-side exterior surface of the apparatus main body 1A. In such a case, the user can access the toner cartridge 70 from the front side of the image forming apparatus and perform the replacement operation of the toner cartridge 70 easily.

When the toner cartridge 70 is at the retracted position, half or more of the length of the toner cartridge 70 in the retraction direction is desirably on the outside of the apparatus. In other words, when viewed in the rotation axis direction of the rotary, with the toner cartridge at the retracted position, half or more of the total length of the toner cartridge in the moving direction of the toner cartridge from the mounted position to the retracted position is desirably outside the main body frame. This applies to each of the toner cartridges 70 including the toner cartridge 70k as an example of the first cartridge and the toner cartridge 70m as an example of the second cartridge. When the toner cartridge 70 is at the retracted position, the entire toner cartridge 70 is more desirably on the outside of the apparatus. In the present embodiment, the front-side exterior surface of the apparatus main body 1A is constituted by the exterior surface 14a of the door 14 and the side surface 16b. However, the configuration of the door 14 is not limited thereto. For example, the door 14 may be configured to have a size such that the entire side surface 16b is covered. In such a case, the front-side exterior surface of the apparatus main body 1A is constituted by the exterior surface 14a of the door 14.

The tray 80 includes a cartridge holding portion 81 (see FIGS. 3 and 6C) that holds the toner cartridge 70. The cartridge holding portion 81 is a to-be-mounted portion where the toner cartridge 70 is mounted. When the tray 80 is at the detachment position, the entire cartridge holding portion 81 is desirably located outside the rotation path of the rotary main body 90 in the retraction direction. When the tray 80 is at the detachment position, half or more of the length of the cartridge holding portion 81 in the retraction direction is desirably on the outside of the apparatus.

As described above, the toner cartridge 70k and tray 80k are larger in size than the other toner cartridges 70y to 70c and trays 80y to 80c. As illustrated in FIGS. 7A and 7B, in the present embodiment, the moving amount of the tray 80 during toner cartridge replacement is thus changed depending on the size of the toner cartridge 70.

Specifically, as illustrated in FIG. 7A, the moving distance when the tray 80k (first support member) moves from the accommodation position (first accommodation position) to the detachment position (first detachment position) is L1. The moving distance when the tray 80m (second support member) moves the from the accommodation position (second accommodation position) to the detachment position (second detachment position) is L2. FIG. 7B illustrates a state where the toner cartridge 70m and the tray 80m are moved. The moving distances when the trays 80y and 80c move from the accommodation position to the detachment position are also L2. Here, L1 is greater than L2. In other words, the moving distance of the first support member when the first toner cartridge moves from the first mounted position to the first retracted position is greater than the moving distance of the second support member when the second toner cartridge moves from the second mounted position to the second retracted position.

As illustrated in FIG. 7A, in the state where the tray 80k is at the detachment position and the toner cartridge 70k is at the retracted position, the toner cartridge 70k protrudes from the exterior surface of the apparatus main body 1A to the outside of the apparatus by a distance P1. In the present embodiment, the tray 80k also protrudes from the exterior surface of the apparatus main body 1A to the outside of the apparatus by the distance P1.

As illustrated in FIG. 7B, in the state where the tray 80m is at the detachment position and the toner cartridge 70m is at the retracted position, the toner cartridge 70m protrudes from the exterior surface of the apparatus main body 1A to the outside of the apparatus by a distance P2. In the present embodiment, the tray 80m also protrudes from the exterior surface of the apparatus main body 1A to the outside of the apparatus by the distance P2. The toner cartridges 70y and 70c also protrude from the exterior surface of the apparatus main body 1A to the outside of the apparatus by the distance P2.

The foregoing distance P1 is greater than the distance P2. To put another way, the protruding length of the first toner cartridge at the first retracted position from the opening 16a of the apparatus main body 1A will be referred to as a first length (P1), and the protruding length of the second toner cartridge at the second retracted position from the opening 16a will be referred to as a second length (P2). In such a case, the first length can be said to be greater than the second length.

For the toner cartridges 70y to 70c that are smaller in size than the toner cartridge 70k, it is desirable in terms of strength that the protruding distance P2 to the outside of the apparatus at the retracted position be smaller than the protruding distance P1 of the toner cartridge 70k to the outside of the apparatus at the retracted position. The reason is as follows. When the toner cartridge 70 is located at the retracted position, at least a part of the toner cartridge 70 protrudes outside the rotation path of the rotary main body 90, or from the exterior surface of the apparatus main body 1A to the outside of the apparatus. Here, the tray 80 supports the weight of the toner cartridge 70 in a state of being cantilevered by the rotary main body 90. Reducing the distance P2 by which the toner cartridges 70y to 70c protrude to the outside of the apparatus at the retracted position can thus reduce the load acting on the trays 80y to 80c and guide units 97 of the rotary main body 90 supporting the trays 80y to 80c. Moreover, since the toner cartridges 70y to 70c are smaller in size than the toner cartridge 70k, the workability of cartridge replacement for the trays 80y to 80c can be maintained even with the distance P2 made shorter than the distance P1.

### (Tray Layout in Rotary)

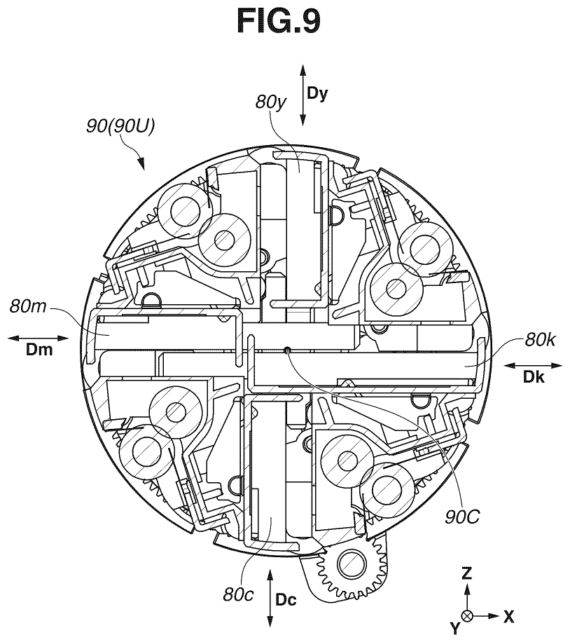

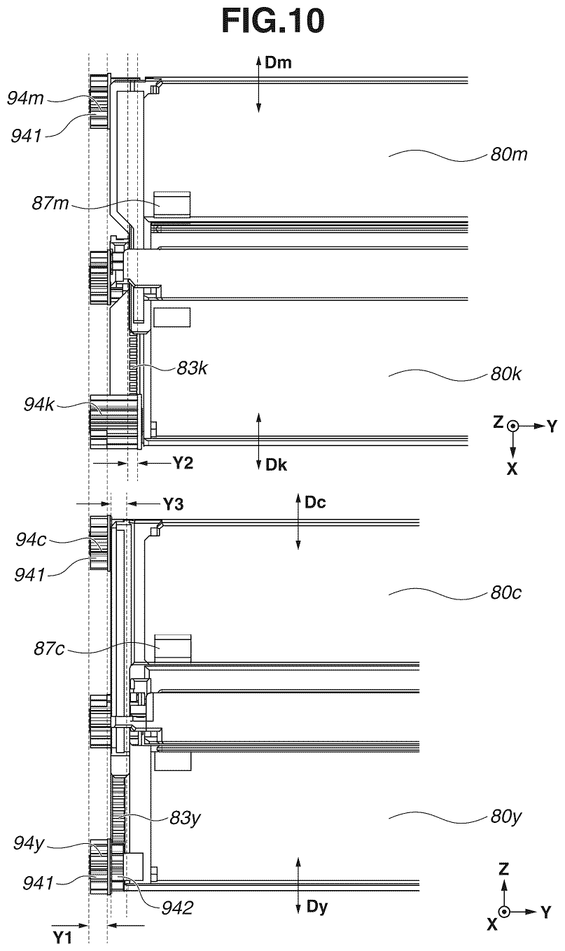

The layout of the trays 80y to 80k in the rotary main body 90 will be described with reference to FIGS. 8, 9, and 10. FIG. 8 is a perspective view illustrating the layout of the trays 80y to 80k in the rotary main body 90. FIG. 9 is a sectional view illustrating the layout of the trays 80y to 80k in the rotary main body 90. FIG. 10 is a diagram illustrating the arrangement of members on one end side of the trays 80y to 80k in the Y direction. FIG. 9 illustrates a cross section of the rotary main body 90, taken along an imaginary plane perpendicular to the rotation axis 90C of the rotary main body 90. The upper half of FIG. 10 is a view of the rotary main body 90 and trays 80m and 80k of FIG. 8, seen from upper right (+Z side) of FIG. 8. The lower half of FIG. 10 is a view of the rotary main body 90 and trays 80c and 80y of FIG. 8, seen from the left (−X side) of FIG. 8.

As illustrated in FIG. 8, the trays 80y to 80k include cartridge holding portions 81y to 81k and to-be-guided portions 82y to 82k, respectively.

The toner cartridges 70y to 70k are mounted on the cartridge holding portions 81y to 81k, respectively. The cartridge holding portions 81y to 81k accommodate at least a part of the toner cartridges 70y to 70k mounted thereon.

The to-be-guided portions 82y to 82k are located at both ends of the trays 80y to 80k in the Y direction, with the cartridge holding portions 81y to 81k therebetween. Each of the to-be-guided portions 82y to 82k is a slender member long in a direction orthogonal to the rotation axis of the rotary main body 90.

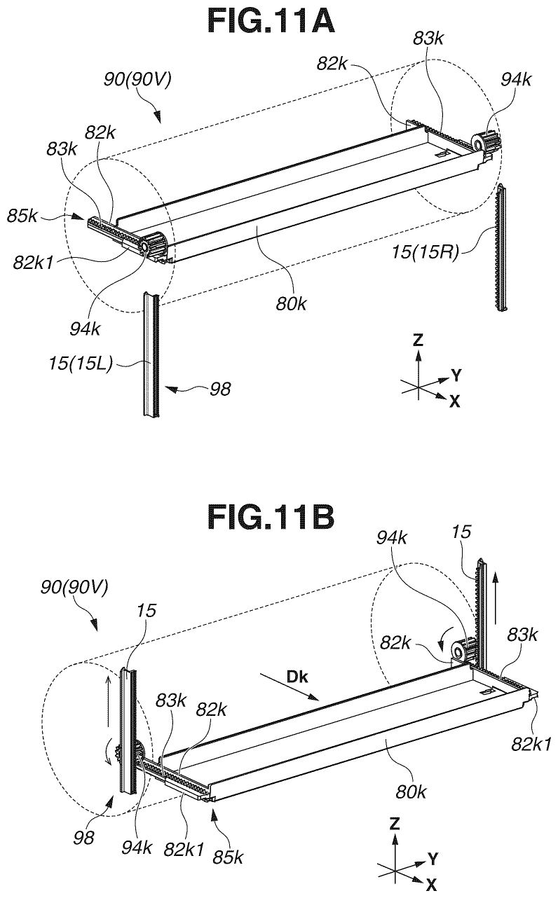

In the present embodiment, reinforcement ribs 82k1 are formed on part of the to-be-guided portions 82k in a moving direction Dk of the tray 80k, and reinforcement ribs 82m1 are formed on part of the to-be-guided portions 82m in a moving direction Dm of the tray 80m (see also FIGS. 11A and 11B). The reinforcement ribs 82k1 and 82m1 are slender rib shapes (protrusions) that protrude outward in the Y direction from the to-be-guided portions 82k and 82m located at both ends of the trays 80k and 80m in the Y direction and extend in the moving directions Dk and Dm of the trays 80k and 80m. The reinforcement ribs 82k1 and 82m1 improve the rigidity of the to-be-guided portions 82k and 82m.

In the present embodiment, the reinforcement ribs 82m1 and 82k1 are limited in length to avoid the to-be-guided portions 82y and 82c. However, the reinforcement ribs 82m1 and 82k1 may be provided over the entire lengths of the to-be-guided portions 82m and 82k if interference with the to-be-guided portions 82y and 82c does not occur. Reinforcement ribs may be added to the to-be-guided portions 82y and 82c as well. If the to-be-guided portions 82m and 82k have sufficient rigidity, the reinforcement ribs 82m1 and 82k1 do not need to be provided.

Rack portions 83y to 83k (rack gears) are formed on the to-be-guided portions 82y to 82k. Pinion gears 94y to 94k are rotatably held inside the rotary main body 90. The pinion gears 94y to 94k mesh with the rack portions 83y to 83k, respectively, in a manner capable of drive transmission.

The rack portions 83y to 83k and the pinion gears 94y to 94k are part of the moving devices 85y to 85k that are configured to move the toner cartridges 70y to 70k from the mounted positions to the retracted positions. The rack portions 83y to 83k and the pinion gears 94y to 94k may be said to be part of to-be-driven devices that are driven by the driving device 98 of the apparatus main body 1A.

The pinion gears 94y to 94k can be said to be rotating bodies (rotating members) that rotate to move the trays 80y to 80k relative to the rotary main body 90.

The pinion gears 94y to 94k and the rack portions 83y to 83k function as to-be-driven units for the moving devices 85y to 85k of the rotary main body 90 to receive driving force from the driving device 98 of the apparatus main body 1A. The pinion gear 94k and the rack portion 83k are an example of a first pinion gear and a first rack gear that constitute at least part of a first-to-be-driven unit included in the first moving device. The pinion gear 94m and the rack portion 83m are an example of a second pinion gear and a second rack gear that constitute at least part of a second-to-be-driven unit included in the second moving device.

The rotary main body 90 includes guide portions 97 (see FIGS. 7A and 7B) that engage with the respective to-be-guided portions 82y to 82k. FIG. 7A illustrates the guide portion 97 (97k) that engages with the to-be-guided portion 82k of the tray 80k. FIG. 7B illustrates the guide portion 97 (97m) that engages with the to-be-guided portion 82m of the tray 80m. The rotary main body 90 includes similar guide portions that engage with the to-be-guided portions 82y and 82c of the trays 80y and 80c. While FIGS. 7A and 7B illustrate the guide portions 97 located on one side (+Y side) of the rotary main body 90 in the Y direction, similar guide portions 97 are also located on the other side (−Y side) of the rotary main body 90 in the Y direction.

When the tray 80 moves between the accommodation position and the detachment position, the guide portions 97 maintain engagement with the to-be-guided portions 82 over at least a part of the range of movement and guide the moving direction of the tray 80. In the present embodiment, the guide portions 97k maintain engagement with the to-be-guided portions 82k over the entire range of movement of the tray 80k from the accommodation position to the detachment position. In the present embodiment, the guide portions 97m maintain engagement with the to-be-guided portions 82m over the entire range of movement of the tray 80m from the accommodation position to the detachment position.

As illustrated in FIGS. 8 and 9, the four trays 80y to 80k are arranged in the rotary main body 90 to overlap each other as will be specifically described below.

As the pinion gears 94y to 94k rotate, the rack portions 83y to 83k and the trays 80y to 80k move relative to the rotary main body 90. As illustrated in FIG. 9, the four trays 80y to 80k are arranged relative to the rotary main body 90 so that their moving directions are 90° rotated from each other. The trays 80y and 80c, and the trays 80m and 80k, are therefore held to be slidable in substantially the same directions (parallel directions). The moving directions of the respective trays 80y to 80k during such slide movement are regulated by the foregoing engagement of the to-be-guided portions 82y to 82k and the guide portions 97.

The trays 80y to 80k move to the outside of the apparatus via the opening 16a. When each of the trays 80y to 80k moves to the outside of the apparatus via the opening 16a, the moving directions of the respective trays are substantially the same (parallel).

As illustrated in FIG. 9, in terms of the moving direction Dk of the tray 80k, the range where the tray 80k is located is positioned to overlap the range where the tray 80y is located and the range where the tray 80c is located. In terms of the moving direction Dk of the tray 80k, the range where the tray 80k is located also overlaps the rotation axis 90C of the rotary main body 90. In other words, the toner cartridge 70k held by the cartridge holding portion 81k of the tray 80k can be said to overlap the rotation axis 90C of the rotary main body (FIG. 4B).

Meanwhile, in the moving direction Dm of the tray 80m, the range where the tray 80m is located is offset to not overlap the range where the tray 80y is located and the range where the tray 80c is located. Moreover, in the moving direction Dy of the tray 80y, the range where the tray 80y is located is offset to not overlap the range where the tray 80m is located and the range where the tray 80k is located. Similarly, in the moving direction Dc of the tray 80c, the range where the tray 80c is located is offset to not overlap the range where the tray 80m is located and the range where the tray 80k is located.

The positional relationship between the trays 80 can also be expressed as follows: As viewed in the moving direction Dy of the tray 80y, the tray 80y and the tray 80k overlap, and the tray 80y and the tray 80m do not overlap. As viewed in the moving direction Dm of the tray 80m, the tray 80m and the tray 80k overlap, and the tray 80m and the trays 80y and 80c do not overlap. As viewed in the moving direction Dc of the tray 80c, the tray 80c and the tray 80k overlap, and the tray 80c ant the tray 80m do not overlap.

As employed herein, two elements (members, parts, units, etc.) overlapping when viewed in a specific direction means that when the elements are perpendicularly projected upon an imaginary plane perpendicular to the direction, the projected area of one of the elements and the projected area of the other overlap at least in part.

As illustrated in FIGS. 8 and 10, in the direction of the rotation axis 90C (Y direction), the range where the rack portion 83m and the to-be-guided portion 82m are located and the range where the rack portion 83k and the to-be-guided portion 82k are located overlap at least in part. In other words, in the present embodiment, the range where the first rack gear (rack portion 83k) is located and the range where the second rack gear (rack portion 83m) is located can be said to overlap at least in part in the rotation axis direction of the rotary (Y direction). Compared to a configuration where the rack portion 83m and the to-be-guided portion 82m do not overlap the rack portion 83k and the to-be-guided portion 82k, the rack portions 83m and 83k and the to-be-guided portions 82m and 82k can thus be arranged in a space-saving manner in the Y direction.

In the direction of the rotation axis 90C (Y direction), the range where the rack portion 83y and the to-be-guided portion 82y are located and the range where the rack portion 83c and the to-be-guided portion 82c are located overlap at least in part. In other words, in the present embodiment, the range where the third rack gear (rack portion 83y) is located and the range where the fourth rack gear (rack portion 83c) is located overlap at least in part in the rotation axis direction of the rotary (Y direction). Compared to a configuration where the rack portion 83y and the to-be-guided portion 82y do not overlap the rack portion 83c and the to-be-guided portion 82c, the rack portions 83y and 83c and the to-be-guided portions 82y and 82c can thus be arranged in a space-saving manner in the Y direction.

Now, the meshing positions of the rack portions 83 and the pinion gears 94 will be described with reference to FIG. 10. The upper half of FIG. 10 illustrates the meshing position of the rack portion 83k and the pinion gear 94k. The lower half of FIG. 10 illustrates the meshing position of the rack portion 83y and the pinion gear 94y.

The driving force transmitted from the motor M2 serving as the driving source (FIG. 2) via the transmission device to be described below is transmitted to the pinion gears 94y to 94k within an area Y1 in the diagram in the direction of the rotation axis 90C of the rotary main body 90 (Y direction). The pinion gear 94k meshes with the rack portion 83k in a manner capable of drive transmission within an area Y2 in the diagram in the Y direction. The pinion gear 94y meshes with the rack portion 83y in a manner capable of drive transmission within an area Y3 in the diagram in the Y direction. Like the rack portion 83k, the rack portion 83m meshes with the pinion gear 94m (FIG. 8) in a manner capable of drive transmission within the area Y2. Like the rack portion 83y, the rack portion 83c meshes with the pinion gear 94c (FIG. 8) in a manner capable of drive transmission within the area Y3.

Here, the areas Y2 and Y3 are located at different positions in the Y direction (offset in the Y direction). The area Y 1 is located at a position different from both the areas Y2 and Y3 in the Y direction. In other words, the area Y1 is offset from the areas Y2 and Y3 in the Y direction.

With the toner cartridges 70y and 70c at the mounted positions, the range where the rack portion 83y is located and the range where the rack portion 83c is located overlap at least in part in the moving direction of the rack portion 83y (the moving direction Dy of the tray 80y). In the present embodiment, since the moving directions Dy and Dc of the trays 80y and 80c are substantially the same (parallel), the range where the rack portion 83y is located and the range where the rack portion 83c is located therefore also overlap at least in part in the moving direction Dc of the tray 80c. With the toner cartridges 70y and 70c at the mounted positions, the tooth faces of the rack portion 83y and the tooth faces of the rack portion 83c are therefore opposed to each other in a direction orthogonal to the moving directions Dy and Dc of the rack portions 83y and 83c (lateral direction in FIG. 8).

Moreover, with the toner cartridges 70m and 70k at the mounted positions, the range where the rack portion 83m is located and the range where the rack portion 83k is located overlap at least in part in the moving direction of the rack portion 83m (the moving direction Dm of the tray 80m). In the present embodiment, since the moving directions Dm and Dk of the trays 80m and 80k are substantially the same (parallel), the range where the rack portion 83m is located and the range where the rack portion 83k is located also overlap at least in part in the moving direction Dk of the tray 80k. With the toner cartridges 70m and 70k at the mounted positions, the tooth faces of the rack portion 83m and the tooth faces of the rack portion 83k are therefore opposed to each other in a direction orthogonal to the moving directions Dm and Dk of the rack portions 83m and 83k (vertical direction in FIG. 8).

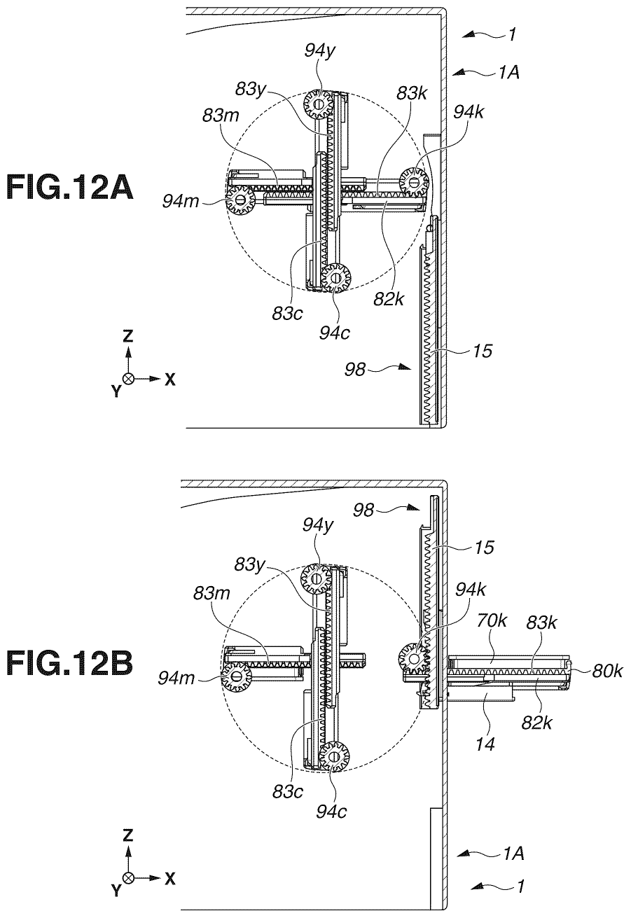

As also illustrated in FIG. 12A to be described below, the rack portion 83y overlaps the rack portions 83m and 83k when viewed in the direction of the rotation axis 90C (Y direction). The rack portion 83m overlaps the rack portions 83y and 83c when viewed in the direction of the rotation axis 90C (Y direction). The rack portion 83c overlaps the rack portions 83m and 83k when viewed in the direction of the rotation axis 90C (Y direction). The rack portion 83k overlaps the rack portions 83y and 83c when viewed in the direction of the rotation axes 90C (Y direction). In other words, the range where the first rack gear (rack portion 83k) is located and the range where the second rack gear (rack portion 83m) is located can be said to not overlap in the rotation axis direction of the rotary (Y direction). With the first toner cartridge 70k at the first mounted position and the second toner cartridge 70y at the second mounted position, the first rack gear (rack portion 83k) and the second rack gear (rack portion 83y) can be said to overlap when viewed in the rotation axis direction of the rotary (Y direction).

Since the positions where the rack portions 83k and 83m are located and the positions where the rack portions 83y and 83c are located are thus different in the Y direction, the rack portions 83y and 83c and the rack portions 83m and 83k can be arranged to overlap as viewed in the Y direction.

This can save space for arranging the four trays in the rotary main body 90 and achieve miniaturization of the rotary main body 90 in the radial direction of rotation. If the rack portions 83 are arranged to not overlap each other when viewed in the Y direction with the moving distances of the respective trays 80y to 80k kept equivalent to those in the present embodiment, the area needed to arrange the four rack portions increases when viewed in the Y direction. Compared to such a configuration, arranging the plurality of rack portions 83 at positions offset in the Y direction so that the rack portions 83 overlap as viewed in the Y direction can reduce the area for arranging the rack portions 83 when viewed in the Y direction.

In the present embodiment, the positions of the four rack portions 83y to 83k in the Y direction are offset in two pairs. In other words, the ranges where the first and second rack gears are located can be said to overlap, and the ranges where the third and fourth rack gears are located can be said to overlap, in the rotation axis direction of the rotary (Y direction). Moreover, the ranges where the first and second rack gears are located can be said to be positioned to not overlap the ranges where the third and fourth rack gears are located in the Y direction. This can miniaturize the rotary main body 90 in the Y direction as compared to the case where the four rack portions 83y to 83k are located at respective different positions in the Y direction.

### (Tray Moving Configuration)

A configuration related to the movement of the trays 80y to 80k arranged in the rotary main body 90 will be described with reference to FIGS. 11A, 11B, 12A, and 12B. FIGS. 11A and 11B are perspective views illustrating a configuration related to the movement of the tray 80k. FIGS. 12A and 12B are sectional views illustrating the configuration related to the movement of the tray 80k.

In the present embodiment, all the trays 80y to 80k are driven by the driving force of the motor M2 being transmitted to the pinion gears 94y to 94k via the drive racks 15L and 15R as a transmission device. Here, a configuration for moving the tray 80k relative to the rotary main body 90 will be described. Configurations for driving the trays 80y to 80c relative to the rotary main body 90 are substantially the same as that for driving the tray 80k, and a description thereof will thus be omitted.

FIG. 11A illustrates a state where the tray 80k is located inside the rotary main body 90 (i.e., where the toner cartridge 70k is mounted to the developing unit 50k). In other words, FIG. 11A illustrates a state where the tray 80k is at the accommodation position, which corresponds to a state where the toner cartridge 70k is at the mounted position relative to the developing frame 53k (FIG. 4A). FIG. 11B illustrates a state where the tray 80k is slid to the outside of the rotary main body 90. In other words, FIG. 11B illustrates a state where the tray 80k is located at the detachment position, which corresponds to a state where the toner cartridge 70k is located at the retracted position relative to the developing frame 53k (FIG. 4B).

The apparatus main body 1A according to the present embodiment includes the drive racks 15L and 15R serving as drive gears for driving the pinion gears 94. Each drive rack 15 is driven by the motor M2 via a non-illustrated drive transmission mechanism.

As described above, the two rack portions 83k are formed on both ends of the tray 80k in the Y direction. The two pinion gears 94k and the two drive racks 15L and 15R are disposed at positions corresponding to the rack portions 83k on both ends. In other words, the apparatus main body 1A according to the present embodiment includes the drive racks 15L and 15R as a first drive gear and a second drive gear. The drive rack 15L can be said to be an example of the first drive gear, and the drive rack 15R an example of the second drive gear.

Note that Such numberings are used merely for the convenience of description, and are in principle interchangeable as appropriate. When distinction is not needed, the drive racks 15L and 15R will be referred to as “drive racks 15”.

The rack portions 83 according to the present embodiment are configured as a rack gear pair, and the pinion gears 94 according to the present embodiment are configured as a pinion gear pair. In the present embodiment, the rack gear pair and the pinion gear pair are located at one end side and the other end side of the support member (tray 80) in the Y direction, but may be located at other positions. The rack portions 83k and the pinion gears 94k of the moving device 85k corresponding to the tray 80k can be said to be an example of a first rack gear pair and a first pinion gear pair, respectively.

The rack portions 83y to 83c and the pinion gears 94y to 94c of the moving device 85y to 85c corresponding to the other trays 80y to 80c can be said to be examples of a second rack gear pair and a second pinion gear pair, respectively.

One of a rack gear pair meshes with one of a pinion gear pair, and the other of the rack gear pair meshes with the other of the pinion gear pair. At least one of the pinion gear pair is driven by the drive rack 15L serving as the first drive rack. In the present embodiment, the pinion gear pair is both driven by the drive racks 15L and 15R serving as the first drive rack and the second drive rack at the same time. This suppresses rotation of the tray 80 and enables stable movement of the toner cartridge 70.

Note that the tray 80 may be configured to have one rack portion 83 and be moved by one drive rack 15 via one pinion gear 94.

The tray 80k is held to be slidable relative to the rotary main body 90 in a direction parallel to the to-be-guided portions 82k (i.e., moving direction Dk). The drive racks 15 are held to be slidable relative to the apparatus main body 1A in a direction intersecting the moving direction Dk of the tray 80k. The drive racks 15 are configured to slide (reciprocate) relative to the apparatus main body 1A in a first direction (in the present embodiment, vertically upward) and a second direction opposite to the first direction (in the present embodiment, vertical downward). In other words, the moving direction of the drive racks 15 according to the present embodiment is a direction intersecting (desirably orthogonal to) both the moving direction Dk of the tray 80k and the direction of the rotation axis 90C of the rotary main body 90 (Y direction).

Tray moving operations for sliding the tray 80k between the accommodation position and the detachment position will be described with reference to FIGS. 11A and 11B. The tray moving operations of the tray 80k are performed by the motor M2 (FIG. 2), the non-illustrated drive transmission mechanism, the drive racks 15, the pinion gears 94k, and the rack portions 83k.

A tray moving operation (tray pull-out operation) in detaching the toner cartridge 70k from the rotary main body 90 will initially be described. In the state before the tray pull-out operation is started, the drive racks 15 are located below the meshing positions with the pinion gears 94k (FIG. 11A). As described above, during the replacement operation of the toner cartridge 70k, the rotary main body 90 assumes the replacement orientation for the toner cartridge 70k (FIG. 4B).

When the tray pull-out operation is started, the drive racks 15 are slid upward relative to the apparatus main body 1A by the driving force of the motor M2. In the moving process, the drive racks 15 come into mesh with the pinion gears 94k, and the pinion gears 94k are driven to rotate.

As illustrated in FIG. 11B, the pinion gears 94k are driven to rotate in the directions of the arrows in the diagram, whereby the driving force is input to the rack portions 83k in mesh with the pinion gears 94k. The tray 80k is thereby pushed out to the outside of the apparatus, moving from the accommodation position to the detachment position relative to the rotary main body 90. The moving direction of the tray 80k here is guided to the predetermined moving direction Dk through engagement of the to-be-guided portions 82k and the guide portions 97k of the rotary main body 90 (FIG. 7A). As a result of the movement of the tray 80k from the accommodation position to the detachment position, the toner cartridge 70k is moved from the mounted position to the retracted position relative to the developing unit 50k.

With the tray 80k located at the detachment position and the toner cartridge 70k located at the retracted position, the user can mount and detach the toner cartridge 70k on/from the tray 80k.

A tray moving operation (tray pull-in operation, tray insertion operation) in mounting the toner cartridge 70 to the rotary main body 90 is performed through processes reverse to those of the tray pull-out operation. In the state before the tray pull-in operation is started, the drive racks 15 are located above the meshing positions with the pinion gears 94k. When the operation is started, the drive racks 15 are slid downward relative to the apparatus main body 1A by the driving force of the motor M2. The rotating direction of the motor M2 in the tray pull-in operation is opposite to in the tray pull-out operation. In the moving process, the drive racks 15 mesh with the pinion gears 94k, and the pinion gears 94k are driven to rotate.

The pinion gears 94K are driven to rotate in the direction opposite to the arrows in FIG. 11B, whereby the driving force is input to the rack portions 83k in mesh with the pinion gears 94k. The tray 80k is thereby pulled into the apparatus, moving from the detachment position to the accommodation position relative to the rotary main body 90.

The moving direction of the tray 80k is guided to the moving direction Dk (direction opposite to the arrow in FIG. 11B) through the engagement of the to-be-guided portions 82k and the guide portions 97k of the rotary main body 90 (FIG. 7A). As a result of the movement of the tray 80k from the detachment position to the accommodation position, the toner cartridge 70k is moved from the retracted position to the mounted position relative to the developing unit 50k.

While the movement of the black tray 80k and toner cartridge 70k has been described above, the other trays 80y to 80c and toner cartridges 70y to 70c are also moved by similar mechanisms. That is, in the replacement orientations for the respective toner cartridges, the drive racks 15 transmit drive to the pinion gears 94y to 94c.

The driving device 98 for driving the moving devices 85 disposed in the rotary main body 90 is constituted by the motor M2 included in the apparatus main body 1A and the transmission device including the drive racks 15 (15L and 15R) and the drive transmission mechanism.

As described above, in the present embodiment, the rotary main body 90 includes the plurality of moving devices 85y to 85k corresponding to the plurality of toner cartridges 70y to 70k. The driving device 98 of the apparatus main body 1A is a common driving device that drives the plurality of moving devices 85k to 85y (plurality of to-be-driven devices) of the rotary main body 90.

In the present embodiment, the driving target of the driving device 98 is switched by the rotation of the rotary main body 90. Specifically, the driving device according to the present embodiment includes the drive racks 15 serving as transmission members for transmitting the driving force of the driving source. The driving device can assume a state where the transmission members are engaged with first to-be-driven portions (pinion gears 94k) in a manner capable of drive transmission and a state where the transmission members are engaged with second to-be-driven portions (pinion gears 94m) in a manner capable of drive transmission. The driving device can also assume a state where the transmission members are disengaged from the first to-be-driven portions and the second to-be-driven portions.

As described above, the pinion gears 94y to 94k are held by the rotary main body 90. When the rotary main body 90 rotates, the pinion gears 94y to 94k and the drive racks 15 are therefore desirably disengaged from each other.

FIG. 12A illustrates a state where the tray 80k is located inside the rotary main body 90 (at the accommodation position). FIG. 12B illustrates a state where the tray 80k is moved to the outside of the rotary main body 90 (moved to the detachment position).

As illustrated in FIG. 12A, when the tray 80k lies inside the rotary main body 90, the drive racks 15 are located in the lower part of the apparatus main body 1A. Here, the drive racks 15 are retracted from the pinion gears 94k. The rotary main body 90 can thus be rotated without interference from the drive racks 15. More specifically, the drive racks 15 can be retracted to the outside of the rotation path of the rotary main body 90, illustrated in a dotted line in FIGS. 12A and 12B.

As described above, the tray 80 mounted to the rotary main body 90 can be moved from the accommodation position to the detachment position and from the detachment position to the accommodation position relative to the rotary main body 90 by driving the motor M2 to rotate forward and backward. In other words, the driving device according to the present embodiment can not only drive each moving device of the rotary so that the toner cartridge moves from the mounted position to the retracted position but also drive each moving device so that the toner cartridge moves from the retracted position to the mounted position.

As described above, in the present embodiment, the moving amount of the tray 80 during toner cartridge replacement is changed depending on the size of the toner cartridge 70. Specifically, as illustrated in FIGS. 7A and 7B, the moving distance L1 when the black tray 80k moves from its accommodation position to detachment position is greater than the moving distance L2 when the other trays 80y to 80c move from their accommodation position to detachment position.

In the present embodiment, in moving the toner cartridges 70y to 70k from their mounted position to retracted position, the value of the speed of the rack portion 83k divided by the speed of the drive racks 15 is greater than the value of the speed of the rack portions 83y to 83c divided by the speed of the drive racks 15.

For example, as illustrated in FIG. 10, the pinion gear 94y is configured as a stepped gear so that the pitch circle radius of a small diameter gear 942 to mesh with the rack portion 83y is smaller than that of a large diameter gear 941 to mesh with the drive rack 15. The pinion gears 94m and 94c are configured as similar stepped gears. On the other hand, the pinion gear 94k is configured to have the same pitch circle radius at the meshing portion with the drive rack 15 and the meshing portion with the rack portion 83k. Here, the pitch circle radius of the pinion gear 94k can be the same as that of the large diameter gears 941 of the pinion gears 94y to 94c. With such a configuration, the moving distance of the rack portion 83k can be made greater than that of the other rack portions 83y to 83c for the same moving distance of the drive rack 15. In other words, the moving distance L1 when the black tray 80k moves from the accommodation position to the detachment position can be made greater than the moving distance L2 when the other trays 80y to 80c move their accommodation position to detachment position.

Since the pinion gears 94y to 94c are configured as stepped gears, the moving direction L1 of the tray 80k can be made greater than the moving direction L2 of the other trays 80y to 80c despite the configuration that the pinion gears 94y to 94k receive driving force from the same drive rack 15.

Instead of (or in combination with) configuring the pinion gears 94y to 94c as stepped gears, the pinion gear 94k may be configured as a stepped gear. In such a case, the portion where the pinion gear 94k meshes with the drive rack 15 can be configured as a small diameter gear, and the portion where the pinion gear 94k meshes with the rack portion 83k as a large diameter gear having a pitch circle radius greater than that of the small diameter gear. The stepped gears are an example of a reduction mechanism, and may be replaced with other conventional reduction mechanisms that reduce the moving amount of the output-side (tray 80-side) member compared to the moving amount of the input-side (driving source-side) member.

The moving amount of the drive racks 15 in moving the toner cartridge 70k from the mounted position to the retracted position may be made greater than the moving amount of the drive racks 15 in moving the toner cartridges 70y to 70c from the mounted position to the retracted position.

The smaller the distance by which the toner cartridge 70 moves from the mounted position to the retracted position, the shorter the moving time of the toner cartridge 70 can be made and the shorter the time for the user to wait for the movement of the toner cartridge 70 can be made. The foregoing configuration where the moving amount of the drive racks 15 relative to the toner cartridge 70k is greater than that of the drive racks 15 relative to the toner cartridges 70y to 70c can reduce the time for the user to wait for the movement of the toner cartridges 70y to 70c.

The foregoing configuration can make the moving distance L1 greater than the moving distance L2. Such configurations can be used in combination.

While the to-be-driven portions are described to include the pinion gears 94 to mesh with both the drive racks 15 and the rack portions 83, the to-be-driven portions may include gears to mesh with the drive racks 15 and gears to mesh with the rack portions 83.

The configuration of the moving devices 85 for moving the trays 80 is not limited to the rack-and-pinion configuration, either. For example, the members corresponding to the pinion gears 94 may be replaced with rollers to be driven to rotate by the motor M2, and the trays 80 may be moved by friction between the rollers and the trays 80.

When the rollers to be driven to rotate by the motor M2 are used, the rollers may be brought into contact with the toner cartridges 70. In such a case, the toner cartridges 70y to 70k may be configured to be directly mountable and detachable to/from the rotary main body 90 without the intermediary of the trays 80y to 80k. In such a case, the moving devices 85 include the rollers.

### (Configuration for Preventing Erroneous Mounting of Toner Cartridges)

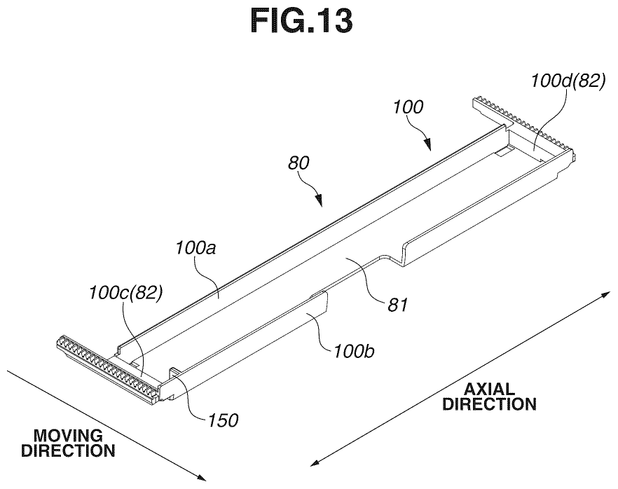

As described above, the toner cartridges 70y to 70k are detachably mounted to the developing units 50y to 50k included in the rotary main body 90, and the developing units 50y to 50k are replenished with the toner from the toner cartridges 70y to 70k. If the toner accommodated in the developing accommodation portion 53a of the developing unit 50 and the toner in the toner cartridge 70 mounted to the developing unit 50 are different in color, the toners of different colors get mixed in the developing accommodation portion 53a. The image forming apparatus 1 thus includes an erroneous mounting prevention configuration for preventing toner cartridges 70 different from compatible ones from being mounted to the developing units 50. The erroneous mounting prevention configuration will be described with reference to FIGS. 13 to 24.

In the following description, one of a recess 30y, a recess 30m, a recess 30c, and a recess 30k to be described below may be referred to as a first recess, one of the remaining three a second recess, one of the remaining two a third recess, and the last one a fourth recess. One of a rib 150y, a rib 150m, a rib 150c, and a rib 150k to be described below may be referred to as a first protrusion, one of the remaining three a second protrusion, one of the remaining two a third protrusion, and the last one a fourth protrusion.

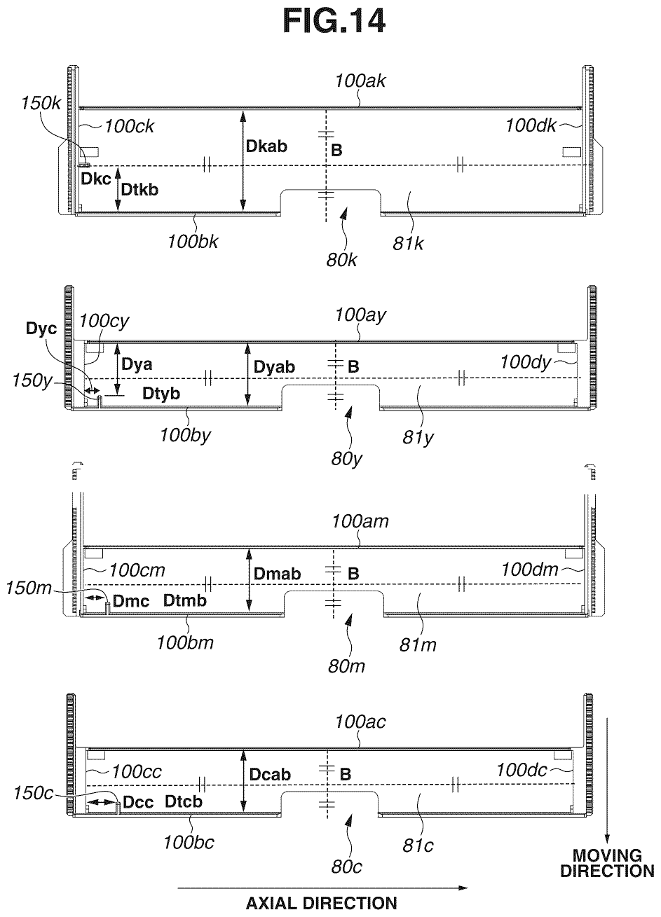

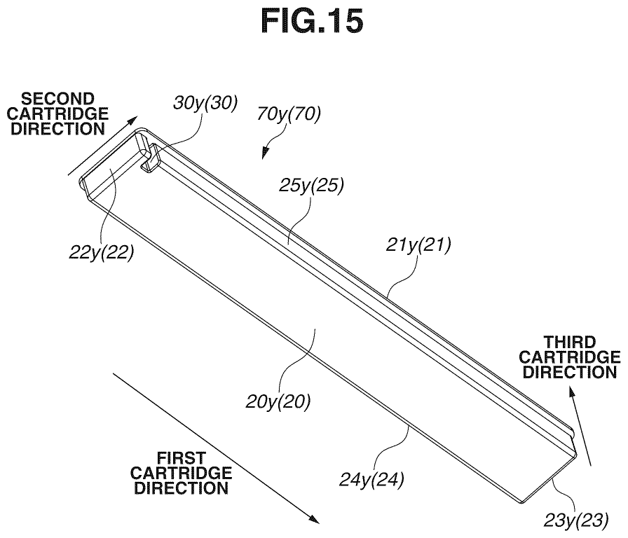

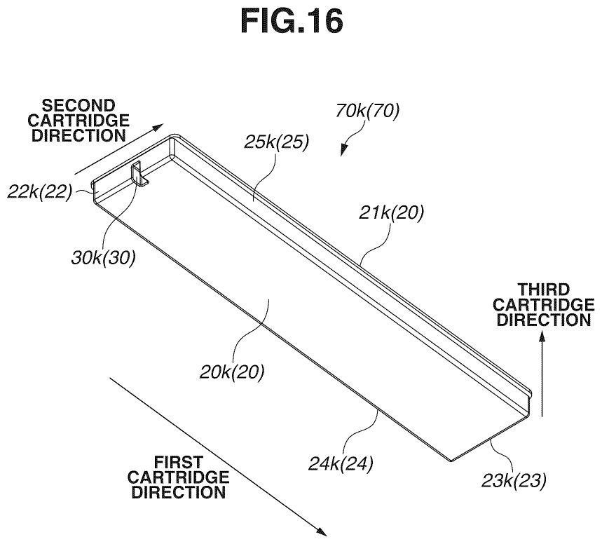

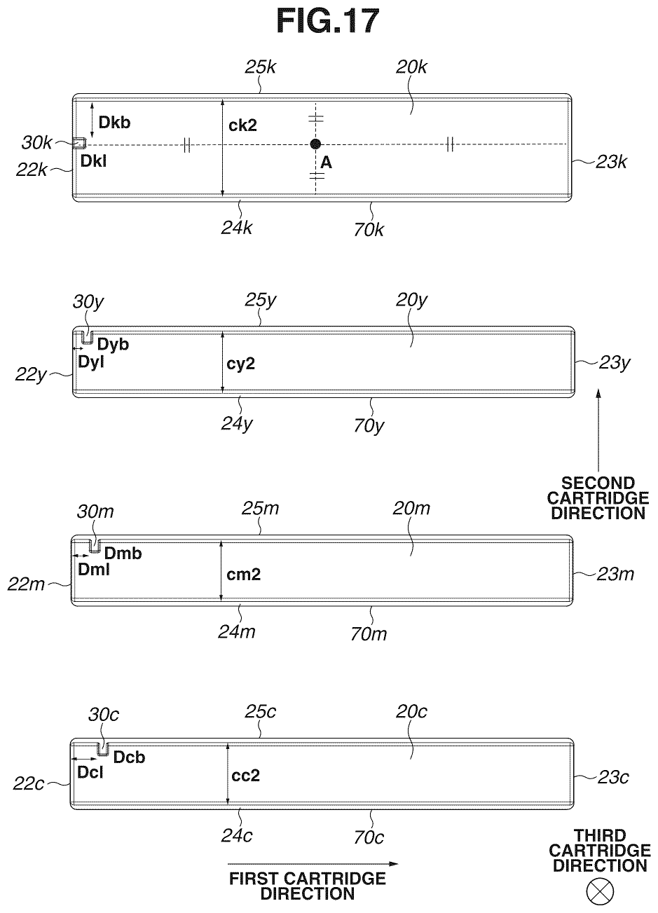

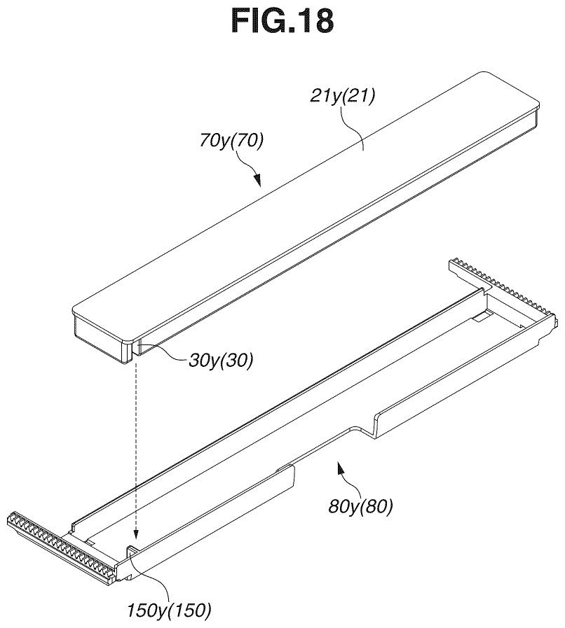

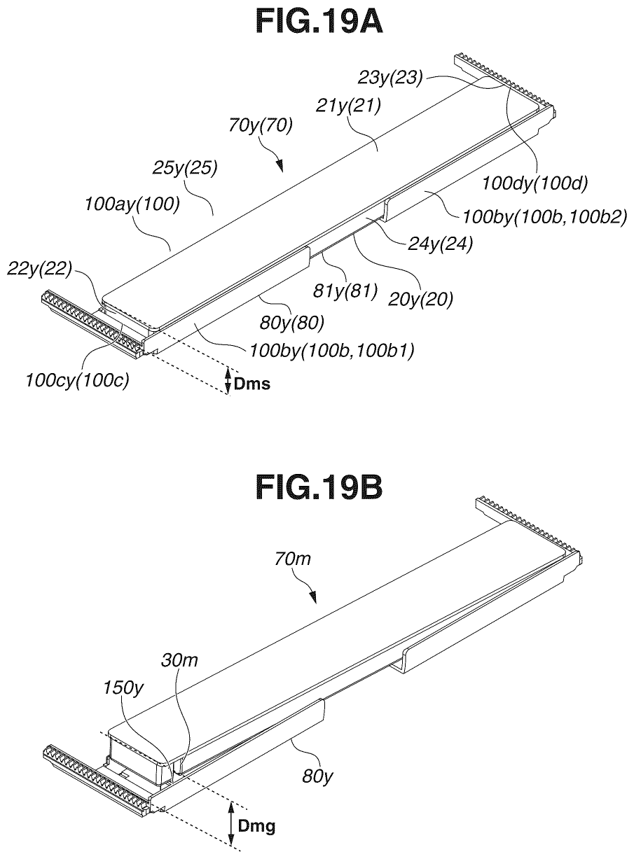

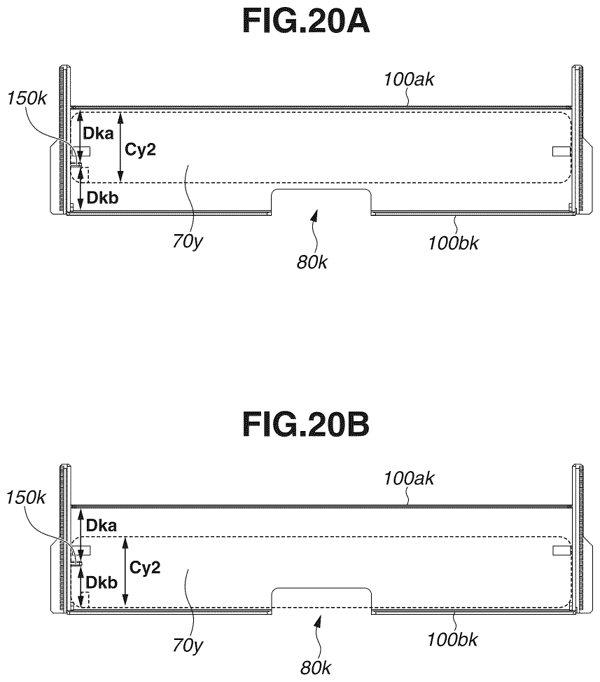

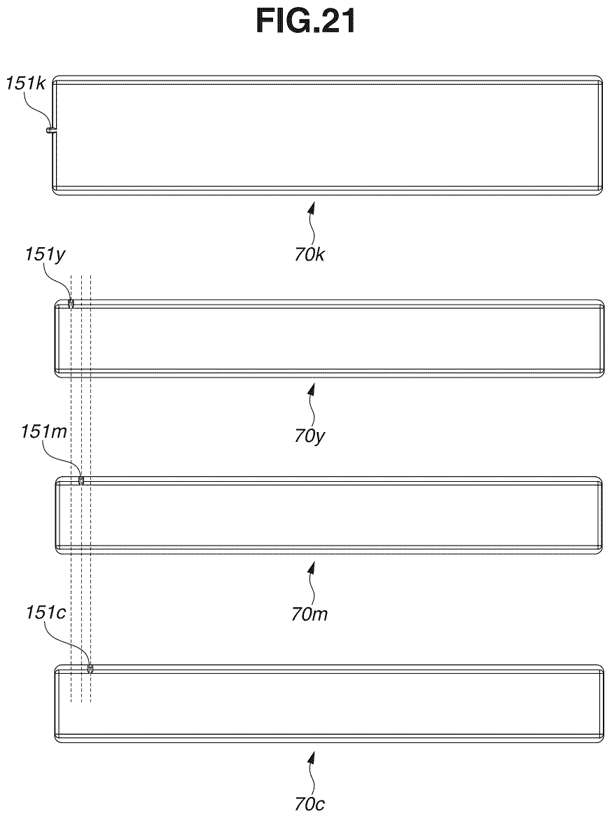

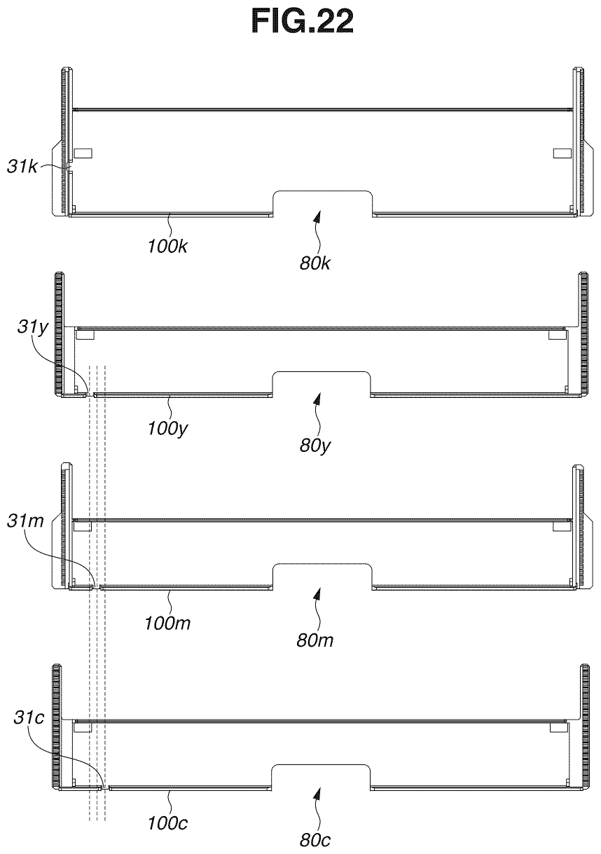

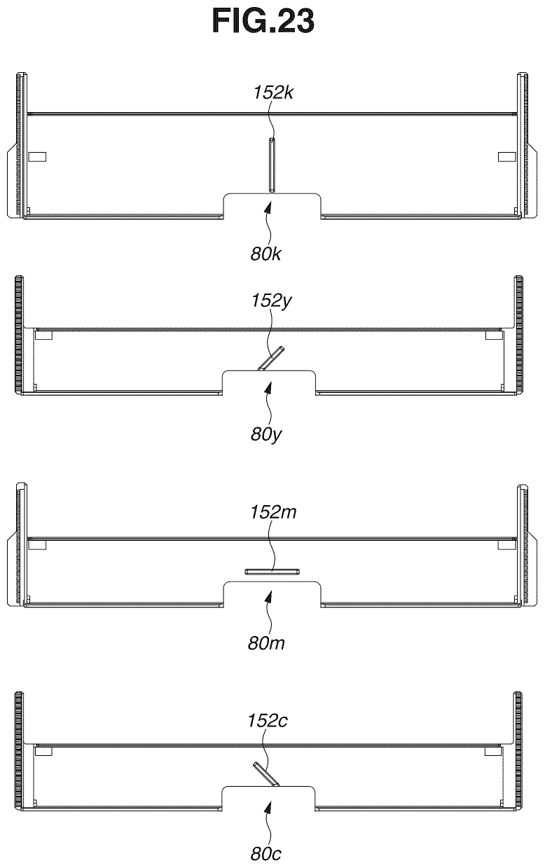

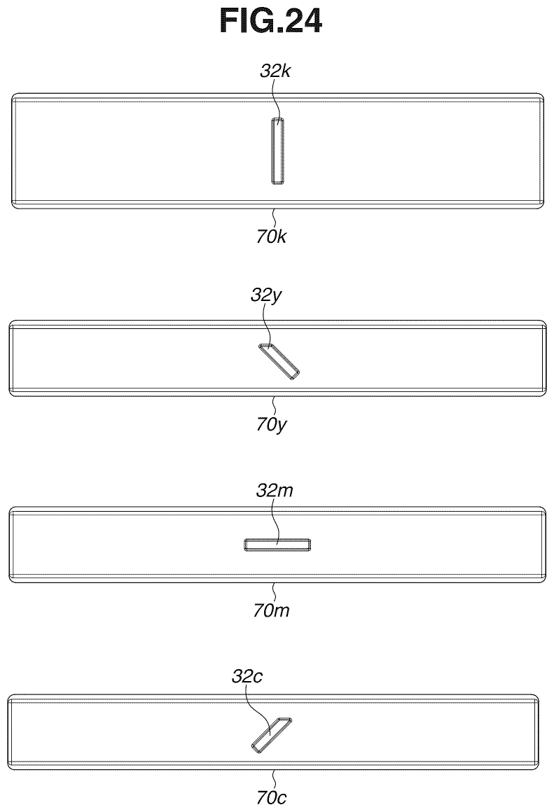

FIG. 13 is a perspective view of the tray 80. FIG. 14 is a plan view of the trays 80y to 80k. More specifically, FIG. 14 is a view of the trays 80y to 80k seen in directions orthogonal to the respective cartridge holding portions 81y to 81k. FIG. 15 is a perspective view of the toner cartridge 70y. FIG. 16 is a perspective view of the toner cartridge 70k. FIG. 17 is a bottom plan view of the toner cartridges 70y to 70k. More specifically, FIG. 17 is a view of the toner cartridges 70y to 70k seen in directions orthogonal to their respective bottom portions 20y to 20k. FIG. 18 is a diagram illustrating a state before the toner cartridge 70y is mounted on the tray 80y. FIG. 19A is a diagram illustrating a state where the toner cartridge 70y is mounted on the tray 80y. FIG. 19B is a diagram illustrating a state where the toner cartridge 70m is mounted on the tray 80y. FIG. 20A is a diagram illustrating a case where the toner cartridge 70y is mounted in contact with a side wall 100ak of the tray 80k, and FIG. 20B a case where the toner cartridge 70y is mounted in contact with a side wall 100bk of the tray 80k. FIG. 21 is a plan view of toner cartridges 70 according to a modification. FIG. 22 is a plan view of trays 80 according to the modification. FIG. 23 is a plan view of trays 80 according to a modification. FIG. 24 is a plan view of toner cartridges 70 according to the modification.

The shape of the tray 80 will be described with reference to FIG. 13. The tray 80 is a tray that supports the toner cartridge 70 in a detachably mountable manner. As illustrated in FIG. 13, the tray 80 includes the cartridge holding portion 81 that supports the toner cartridge 70, and side walls 100 that are located around the cartridge holding portion 81 and extend in a direction orthogonal to the cartridge holding portion 81. With the tray 80 at the detachment position, the side walls 100 extend from the cartridge holding portion 81 in a direction intersecting horizontal directions (desirably in the vertical direction).

The side walls 100 include a side wall 100a and a side wall 100b that extend in the direction of the rotation axis 90C (axial direction). The side wall 100a is located at one end of the tray 80 and the side wall 100b is located at the other end of the tray 80 in the moving direction of the tray 80. More specifically, in the direction orthogonal to the axial direction, the side wall 100a is closer to the rotation axis 90C of the rotary main body 90 than the cartridge holding portion 81 and the side wall 100b. In the direction orthogonal to the axial direction, the side wall 100b is farther from the rotation axis 90C of the rotary main body 90 than the cartridge holding portion 81 and the side wall 100a. In the direction orthogonal to the axial direction, the side walls 100a and 100b are opposed to each other, and the cartridge holding portion 81 is located between the side walls 100 and 100b. Note that the side walls 100a and 100b do not need to be parallel to each other.

The side walls 100 include a side wall 100c and a side wall 100d that extend in the moving direction of the tray 80 moving to the accommodation position and the detachment position. In other words, the first tray includes a first side wall (side wall 100c or side wall 100d) extending in a first moving direction in which the first tray is displaced from the first position to the second position. The second tray includes a second side wall (side wall 100c or side wall 100d) extending in a second moving direction in which the second tray is displaced from the third position to the fourth position.

In the axial direction, the side wall 100c is located at one end side of the tray 80 and the side wall 100d is located at the other end side of the tray 80. More specifically, as viewed in the moving direction in which the tray 80 moves from the accommodation position to the detachment position, the side wall 100c is located on the right of the cartridge holding portion 81, and the side wall 100d is located on the left of the cartridge holding portion 81. In the axial direction, the side walls 100c and 100d are opposed to each other, and the cartridge holding portion 81 is located between the side walls 100c and 100d. The extending direction of the side wall 100c is a direction intersecting (desirably, a direction orthogonal to) the extending direction of the side wall 100a and the extending direction of the side wall 100b. The extending direction of the side wall 100d is a direction intersecting (desirably, a direction orthogonal to) the extending direction of the side wall 100a and the extending direction of the side wall 100b. The side walls 100c and 100d are provided with the to-be-guided portions 82. The side walls 100c and 100d do not need to be parallel to each other.

The toner cartridge 70 is mounted on a mounting portion of the tray 80. The mounting portion of the tray 80 is formed by the cartridge holding portion 81 and the side walls 100a to 100d. In the axial direction, the length of the mounting portion is the same as the shortest distance between the side wall 100c and the side wall 100d. In the present embodiment, the shortest distance between the side wall 100c and the side wall 100d in the axial direction is the same as the length of the cartridge holding portion 81 in the axial direction. In the moving direction of the tray 80 (the direction orthogonal to the axial direction), the length of the mounting portion is the same as the shortest distance between the side wall 100a and the side wall 100b. In the present embodiment, the shortest distance between the side wall 100a and the side wall 100b in the moving direction of the tray 80 is the same as the length of the cartridge holding portion 81 in the moving direction of the tray 80. The tray 80 also includes a rib (protrusion) 150. Specifically, the tray 80y includes a first restriction portion (first protrusion). The tray 80m includes a second restriction portion (second protrusion). The tray 80c includes a third restriction portion (third protrusion). The tray 80k includes a fourth restriction portion (fourth protrusion). The arrangement and function of the ribs 150 will be described below.

As illustrated in FIG. 14, in the moving directions of the trays 80, the length of the cartridge holding portion 81k is greater than those of the cartridge holding portion 81y, the cartridge holding portion 81m, and the cartridge holding portion 81c. In other words, in the moving directions of the trays 80, a shortest distance Dkab between the side wall 100ak and the side wall 100bk of the tray 80k is greater than a shortest distance Dyab between the side wall 100ay and the side wall 100by of the tray 80y, a shortest distance Dmab between the side wall 100am and the side wall 100bm of the tray 80m, and a shortest distance Dcab between the side wall 100ac and the side wall 100bc of the tray 80c. In the present embodiment, the lengths of the cartridge holding portions 81y to 81c in the moving directions of the trays 80 are the same. In other words, in the moving directions of the trays 80, the shortest distance between the side wall 100ay and the side wall 100by, the shortest distance between the side wall 100am and the side wall 100bm, and the shortest distance between the side wall 100ac and the side wall 100bc are the same.

On the other hand, in the present embodiment, the lengths of the cartridge holding portions 81y to 81k in the axial direction are the same. In other words, in the axial direction, the shortest distance between the side wall 100cy and the side wall 100dy, the shortest distance between the side wall 100cm and the side wall 100dm, the shortest distance between the side wall 100cc and the side wall 100dc, and the shortest distance between the side wall 100ck and the side wall 100dk are the same.

The shapes and positions of the ribs 150 included in the trays 80 will be described with reference to FIG. 14. The trays 80y to 80b include the ribs 150y to 150k, respectively. In the present embodiment, the ribs 150y to 150k are rectangular parallelopipeds. The ribs 150y to 150k have the same size and the same shape.

The rib 150y is connected to the cartridge holding portion 81y and the side wall 100by of the tray 80y. The rib 150m is connected to the cartridge holding portion 81m and the side wall 100bm of the tray 80m. The rib 150c is connected to the cartridge holding portion 81c and the side wall 100bc of the tray 80c. The rib 150k is connected to the cartridge holding portion 81k and the side wall 100ck of the tray 80k.

As illustrated in FIG. 14, in the direction (axial direction) of the rotation axis 90C, a shortest distance Dyc between the rib 150y and the side wall 100cy, a shortest distance Dmc between the rib 150m and the side wall 100cm, a shortest distance Dcc between the rib 150c and the side wall 100cc, and a shortest distance Dkc between the rib 150k and the side wall 100ck are different from each other. In the present embodiment, the shortest distance Dkc between the rib 150k and the side wall 100ck in the axial direction is zero.

In the moving directions of the trays 80, a shortest distance Dyb between the rib 150y and the side wall 100by, a shortest distance Dmb between the rib 150m and the side wall 100bm, and a shortest distance Dcb between the rib 150c and the side wall 100bc are the same. In the moving directions of the trays 80, a shortest distance Dkb between the rib 150k and the side wall 100bk is different from Dyb, Dmb, or Dcb. In the present embodiment, Dyb, Dmb, and Dcb in the moving directions of the trays 80 are zero.

In the moving directions of the trays 80, the shortest distance between the rib 150y and the side wall 100by, the shortest distance between the rib 150m and the side wall 100bm, the shortest distance between the rib 150c and the side wall 100bc, and the shortest distance between the rib 150k and the side wall 100bk may be made different from each other.

Next, the shape of the toner cartridge 70 will be described with reference to FIGS. 15, 16, 17, 18, and 19A. The toner cartridge 70 is a substantially rectangular parallelopiped. The longitudinal direction of the toner cartridge 70 will be referred to as a first cartridge direction, a direction orthogonal to the first cartridge direction and parallel to a bottom portion 20 a second cartridge direction (transverse direction), and a direction orthogonal to the first and second cartridge directions a third cartridge direction (thickness direction). The length of the toner cartridge 70 in the first cartridge direction is greater than the length in the second cartridge direction. The length in the second cartridge direction is greater than the length in the third cartridge direction.

The toner cartridge 70 includes the bottom portion 20, a top portion 21, and side portions 22, 23, 24, and 25. The top portion 21 is located opposite to the bottom portion 20 in the third cartridge direction. The side portions 22 and 23 are surfaces extending in the second cartridge direction. The side portions 24 and 25 are surfaces extending in the first cartridge direction. The side portion 22 is located opposite to the side portion 23 in the first cartridge direction. The side portion 24 is located opposite to the side portion 25 in the second cartridge direction. The length of the side portions 24 and 25 in the first cartridge direction is greater than that of the side portions 22 and 23 in the second cartridge direction. The length of the side portions 22 and 23 in the second cartridge direction is greater than that of the side portions 22 and 23 in the third cartridge direction (which is the same as the shortest distance between the bottom portion 20 and the top portion 21 in the third cartridge direction).

As illustrated in FIG. 19A, in the state where the toner cartridge 70 compatible with the tray 80 is normally mounted on the tray 80, the bottom portion 20 is opposed to the cartridge holding portion 81 of the tray 80 and supported by the cartridge holding portion 81. In the axial direction, the side portion 22 is opposed to the side wall 100c, and the side portion 23 is opposed to the side wall 100d. In the moving direction of the tray 80, the side portion 24 is opposed to the side wall 100a, and the side portion 25 is opposed to the side wall 100b.

As illustrated in FIGS. 15 and 16, the toner cartridge 70 includes a recess (opening) 30 into which the rib 150 of the tray 80 can be inserted. More specifically, the toner cartridge 70y includes a first recess, the toner cartridge 70m includes a second recess, the toner cartridge 70c includes a third recess, and the toner cartridge 70k includes a fourth recess. As illustrated in FIGS. 18 and 19A, with the compatible toner cartridge 70 mounted on the tray 80, the rib 150 of the toner cartridge 70 is inserted in the recess 30. More specifically, the rib 150y of the tray 80y can be inserted into the recess 30y of the toner cartridge 70y. The rib 150c of the tray 80c can be inserted into the recess 30c of the toner cartridge 70c. The rib 150m of the tray 80m can be inserted into the recess 30m of the toner cartridge 70m. The rib 150k of the tray 80k can be inserted into the recess 30k of the toner cartridge 70k.

In the present embodiment, the recesses 30y to 30k have the same shape and the same size. As illustrated in FIGS. 15 and 16, each of the recesses 30 of the ton er cartridges 70y to 70c is formed across the bottom portion 20 and the side portion 25. The recess 30 of the toner cartridge 70k is formed across the bottom portion 20 and the side portion 23.

Next, the positional relationship of the recesses 30 in the toner cartridges 70y to 70k will be described with reference to FIG. 17. As illustrated in FIG. 17, the length of the toner cartridge 70k in the second cartridge direction is greater than that of the toner cartridges 70y to 70c in the second cartridge direction. In the first cartridge direction, a shortest direction dyl between the recess 30y and the side portion 22y, a shortest distance dml between the recess 30m and the side portion 22m, a shortest distance del between the recess 30c and the side portion 22c, and a shortest distance dkl between the recess 30k and the side portion 22k are different from each other. In the second cartridge direction, a shortest distance dyb between the recess 30y and the side portion 25y, a shortest distance dmb between the recess 30m and the side portion 25m, and a shortest distance dcb between the recess 30c and the side portion 25c are the same. In the second cartridge direction, a shortest distance dkb between the recess 30k and the side portion 25k is different from each of the shortest distance dyb between the recess 30y and the side portion 25y, the shortest distance dmb between the recess 30m and the side portion 25m, and the shortest distance dcb between the recess 30c and the side portion 25c. As viewed in the third cartridge direction, a straight line that passes through the center A of a line segment connecting the side portion 25k and the side portion 25k of the toner cartridge 70k by the shortest distance and extends in the direction of the rotation axis 90C overlaps the recess 30k.

### (Normal Mounting of Toner Cartridge)

Next, a case where the toner cartridge 70 is mounted on the compatible tray 80 in a correct direction will be described with reference to FIGS. 18 and 19A.

As illustrated in FIG. 18, when the toner cartridge 70y is mounted on the tray 80y in the correct direction, the rib 150y is inserted in the recess 30y.

As illustrated in FIG. 19A, with the toner cartridge 70y mounted on the tray 80y in the correct direction, the toner cartridge 70y assumes a normal orientation that is the orientation normal for the tray 80y. Here, the bottom portion 20y is opposed to the cartridge holding portion 81y of the tray 80y and supported by the cartridge holding portion 81y. In the axial direction, the side portion 22y is opposed to the side wall 100cy, the side portion 23y is opposed to the side wall 100dy, and the side portions 22y and 23y are located between the side walls 100cy and 100dy. In the moving direction of the tray 80y, the side portion 24y is opposed to the side wall 100ay, the side portion 25y is opposed to the side wall 100by, and the side portions 24y and 25y are located between the side walls 100ay and 100by. Moreover, the rib 150y is inserted in the recess 30y. In other words, when the tray 80 supports the toner cartridge 70y so that the rib 150y is inserted in the recess 30y, the toner cartridge 70y assumes the normal orientation that is the orientation normal for the tray 80y.

If the toner cartridge 70y is reversed so that the side portion 22y is opposed to the side wall 100dy and the side portion 23y is opposed to the side wall 100cy in the axial direction, the rib 150y contacts the toner cartridge 70y and the toner cartridge 70y is restricted from assuming the normal orientation relative to the tray 80y. If the toner cartridge 70y is reversed so that the side portion 24y is opposed to the side wall 100by and the side portion 25y is opposed to the side wall 100ay in the moving direction of the tray 80y, the rib 150y contacts the toner cartridge 70y and the toner cartridge 70y is restricted from assuming the normal orientation relative to the tray 80y. If the toner cartridge 70y is inverted so that the top portion 21 of the toner cartridge 70y is opposed to the cartridge holding portion 81y, the rib 150y contacts the toner cartridge 70y and the toner cartridge 70y is restricted from assuming the normal position relative to the tray 80y.

In other words, if the toner cartridge 70y is reversed from the correct direction in one or two of the first cartridge direction, the second cartridge direction, and the third cartridge direction, the rib 150y contacts the toner cartridge 70y and the toner cartridge 70y is restricted from assuming the normal orientation relative to the tray 80y.

When the tray 80 is moved from the detachment position to the accommodation position, the toner cartridge 70 supported in the normal orientation moves from the retracted position to the mounted position relative to the rotary main body 90 (more specifically, relative to the developing frame 53 of the developing unit 50). In other words, the tray 80 is displaced relative to the rotary main body 90 to a position where the toner cartridge 70 supported in the normal orientation is located outside the rotary main body 90 (detachment position) and a position where the toner cartridge 70 is located inside the rotary main body 90 (accommodation position).

The mounting of the toner cartridge 70y on the tray 80y, the mounting of the toner cartridge 70m on the tray 80m, the mounting of the toner cartridge 70c on the tray 80c, and the mounting of the toner cartridge 70k on the tray 80k are performed in a similar manner. In other words, the toner cartridge 70m is mounted on the tray 80m in the normal orientation, the toner cartridge 70c is mounted on the tray 80c in the normal orientation, and the toner cartridge 70k is mounted on the tray 80k in the normal orientation. A description will thus be omitted of the mounting of the toner cartridge 70m on the tray 80m, the mounting of the toner cartridge 70c on the tray 80c, and the mounting of the toner cartridge 70k on the tray 80k.

In such a manner, the first toner cartridge is supported by the first tray and assumes the first orientation (normal orientation). The second toner cartridge is supported by the second tray and assumes the second orientation (normal orientation).

### (Erroneous Mounting of Toner Cartridge)

A case where the toner cartridge 70 is mounted on an incompatible tray 80 (erroneous mounting of the toner cartridge) will be described with reference to FIG. 19B.

The toner cartridges 70y to 70k, when supported by incompatible trays 80y to 80k, assume an erroneously mounted orientation that is not the normal orientation. More specifically, the rib 150 contacts the toner cartridge 70 and an erroneously mounted orientation that is not the normal orientation is assumed.

For example, if the tray 80y supports the toner cartridge 70m as illustrated in FIG. 19B, the toner cartridge 70m assumes an erroneously mounted orientation. In other words, the rib 150y has a function as a restriction unit that restricts the toner cartridge 70m from assuming the same orientation relative to the tray 80y as the normal orientation that the toner cartridge 70y assumes relative to the tray 80y. With the tray 80y supporting the toner cartridge 70m, the rib 150y contacts the toner cartridge 70m. This restricts the toner cartridge 70m from assuming the same orientation relative to the tray 80y as the normal orientation that the toner cartridge 70y assumes relative to the tray 80y. In other words, when the first tray supports the second cartridge, the first restriction portion of the first tray contacts the second cartridge and restricts the second cartridge from assuming the same orientation as the first orientation relative to the first tray. When the second tray supports the first cartridge, the second restriction portion of the second tray contacts the first cartridge and restricts the first cartridge from assuming the same orientation as the second orientation relative to the second tray.

As illustrated in FIG. 19B, with the toner cartridge 70m supported by the tray 80y, the distance between the uppermost portion of the toner cartridge 70m and the rib 150y in the direction orthogonal to the cartridge holding portion 81y (i.e., the direction orthogonal to the moving direction of the tray 80 and the direction of the rotation axis 90C) will be referred to as a distance Dmg. On the other hand, as illustrated in FIG. 19A, with the toner cartridge 70y supported by the tray 80y in the normal orientation, the distance between the uppermost portion of the tray 80y and the rib 150y in the direction orthogonal to the cartridge holding portion 81y will be referred to as a distance Dms. Here, the distance Dmg is greater than the distance Dms. Note that the erroneously mounted orientation of FIG. 19B is merely an example, and the toner cartridge 70 assumes various erroneously mounted orientations depending on how the toner cartridge 70 is supported by the tray 80.

In the present embodiment, as illustrated in FIGS. 19A and 19B, the normal orientation of the toner cartridge 70 differs in tilt from the erroneously mounted orientation of the toner cartridge 70. More specifically, as illustrated in FIG. 19B, when the toner cartridge 70 is erroneously mounted, the bottom surface 20 of the toner cartridge 70 is tilted relative to the cartridge holding portion 81. When the user mounts the toner cartridge 70 on an incompatible tray 80, the toner cartridge 70 thus assumes an erroneously mounted orientation different from the normal orientation. This facilitates the user recognizing the erroneous mounting. Note that the position of the toner cartridge 70 relative to the tray 80 only needs to differ between the normal orientation and the erroneously mounted orientation of the toner cartridge 70, and the toner cartridge 70 in the erroneously mounted orientation does not need to be tilted relative to the tray 80.

The mounting of the toner cartridge 70c on the tray 80y, the mounting of the toner cartridges 70y and 70c on the tray 80m, and the mounting of the toner cartridges 70y and 70m on the tray 80c are similar to the mounting of the toner cartridge 70m on the tray 80y. A description thereof will thus be omitted.

In the present embodiment, the length of the toner cartridges 70y to 70k in the first cartridge direction is greater than the distances from the side walls 100c of the trays 80y to 80k to the ribs 150 and the distances from the side walls 100d to the ribs 150. If a wrong toner cartridge 70 is moved in the direction of the rotation axis 90C and supported by the tray 80 so that the cartridge holding portion 81 and the bottom portion 20 are opposed to each other and the toner cartridge 70 does not overlap the rib 150, the toner cartridge 70 therefore contacts the side wall 100c or 100d and is unable to be properly mounted.

Next, situations where a wrong toner cartridge 70 is mounted on the tray 80k will be described with reference to FIGS. 20A and 20B. As described above, the length of the cartridge holding portion 81k in the moving direction of the tray 80 is greater than that of each of the cartridge holding portions 81y, 81m and 81c. The tray 80k can thus support the toner cartridge 70y in contact with the side wall 100ak of the tray 80k as illustrated in FIG. 20A, or support the toner cartridge 70y in contact with the side wall 100bk of the tray 80k as illustrated in FIG. 20B. However, a shortest distance Dka between the side wall 100ak and the rib 150k of the tray 80k in the moving direction of the tray 80 and the shortest distance Dkb between the side wall 100bk and the rib 150k of the tray 80k in the moving direction of the tray 80 are smaller than a length Cy2 of the toner cartridge 70y in the second cartridge direction. Even if the supporting position of the toner cartridge 70y is moved in the moving direction of the tray 80, the toner cartridge 70y thus contacts the rib 150k and assumes an erroneously mounted orientation. That is, this prevents the toner cartridge 70y from being supported by the tray 80k to avoid the rib 150k.

The shortest distance Dka between the side wall 100ak and the rib 150k of the tray 80k and the shortest distance Dkb between the side wall 100bk and the rib 150k of the tray 80k are smaller than a length Cm2 of the toner cartridge 70m in the second cartridge direction and smaller than a length Cc2 of the toner cartridge 70c in the second cartridge direction. The mounting of the toner cartridges 70m and 70c on the tray 80k is therefore similar to that of the toner cartridge 70y on the tray 80k. A description thereof will thus be omitted.

On the other hand, a shortest distance Dya between the side wall 100ay and the rib 150y of the tray 80y in the moving direction of the tray 80 and the shortest distance Dyb between the side wall 100by and the rib 150y of the tray 80y in the moving direction of the tray 80 are smaller than a length Ck2 of the toner cartridge 70k in the second cartridge direction. Moreover, the shortest distance Dyab between the side walls 100ay and 100by of the tray 80y in the moving direction of the tray 80y is smaller than the length Ck2 of the toner cartridge 70k in the second cartridge direction. When the tray 80y supports the toner cartridge 70k, at least one of the side walls 100a and 100b thus contacts the toner cartridge 70k and restricts the toner cartridge 70k from assuming the same orientation as the normal orientation relatively to the tray 80k.

The shortest distance Dmab between the side walls 100am and 100bm of the tray 80m in the moving direction of the tray 80m is smaller than the length Ck2 of the toner cartridge 70k in the second cartridge direction. Moreover, the shortest distance Dcab between the side walls 100ac and 100bc of the tray 80c in the moving direction of the tray 80c is smaller than the length Ck2 of the toner cartridge 70k in the second cartridge direction. The mounting of the toner cartridge 70k on the trays 80m and 80c is thus similar to that of the toner cartridge 70k on the tray 80y. A description thereof will thus be omitted.

### Modifications

In the present embodiment, the rib 150 is disposed on the tray 80, and the recess 30 is disposed in the toner cartridge 70. However, as illustrated in FIGS. 21 and 22, a recess 31 may be disposed in the tray 80 and a rib 151 may be disposed on the toner cartridge 70.

More specifically, when the toner cartridges 70y to 70k are mounted on the compatible trays 80y to 80k, the ribs 151y to 151k are inserted in the recesses 31y to 31k. On the other hand, when the toner cartridges 70y to 70k are mounted on incompatible trays 80y to 80k, the ribs 151y to 151k contact the side walls 100y to 100d of the trays 80y to 80k. In such a case, the contact portion of the tray 80 contacting the rib 151 restricts the toner cartridge 70 from assuming the normal orientation relative to the tray 80. In other words, the first cartridge includes the first protrusion and the first tray includes the first recess, and the second cartridge includes the second protrusion and the second tray includes the second recess. When the first tray supports the second cartridge, the first restriction portion contacts the second protrusion. When the second tray supports the first cartridge, the second restriction portion contacts the first protrusion.

The ribs 150y to 150k have the same shape. However, as illustrated in FIG. 23, ribs 152y to 152k may have different shapes when seen in directions orthogonal to the cartridge holding portions 81 (i.e., directions orthogonal to the axial direction of the rotary main body 90). As illustrated in FIG. 24, recesses 32y to 32k may have different shapes accordingly. Note that different shapes also include similar shapes of different sizes, as well as similar shapes of the same size but in different directions like those illustrated on the trays 80y and 80c of FIG. 23.

In the present embodiment, the tray 80 includes a single rib 150. However, the tray 80 may include one or more ribs 150 or one or more recesses 30. The toner cartridge 70 may also include one or more ribs 150 or one or more recesses 30 accordingly.

As illustrated in FIG. 17, the recess 30 of the toner cartridge 70 is located closer to the side portion 22 of the cartridge than the center A of the toner cartridge 70. In other words, as viewed in the third cartridge direction, the shortest distance between the center of the side portions 22 and 23 and the recess 30 is greater than the shortest distance between the recess 30 and the side portion 22. As illustrated in FIG. 14, as viewed in the direction orthogonal to the cartridge holding portion 81 with the position at the center between the side walls 100a and 100b and the center between the side walls 100c and 100d as a center B, the rib 150 of the tray 80 is accordingly closer to the side wall 100c than the center position. Disposing the recess 30 closer to the side wall in such a manner can improve the degree of freedom in designing the interior of the toner cartridge 70.

While in the present embodiment the tray 80 includes the side walls 100a to 100d, the tray 80 may be configured to include at least one or more of the side walls. The tray 80 may be configured without the side walls 100.

### (Configuration for Preventing Erroneous Mounting Through Restriction of Tray Movement)

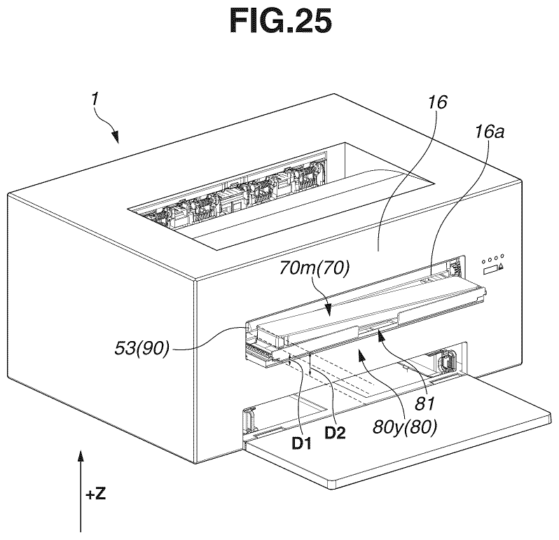

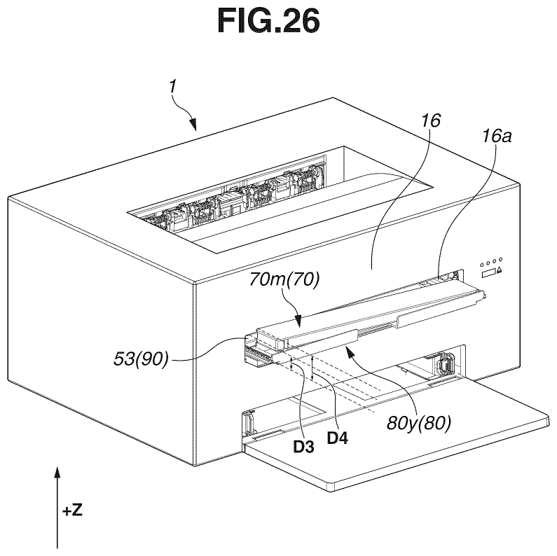

A configuration for restricting a toner cartridge 70 that is incompatible with the tray 80 from moving to the mounted position when the toner cartridge 70 is supported on the tray 80 will be described with reference to FIGS. 25 and 26.

FIGS. 25 and 26 are diagrams illustrating states where a toner cartridge 70 incompatible with the tray 80 is supported on the tray. FIGS. 25 and 26 show the states where the toner cartridge 70m is mounted on the tray 80y.

In the image forming apparatus 1 according to the present embodiment, when the tray 80 is moved from the detachment position to the accommodation position with a toner cartridge 70 incompatible with the tray 80 supported on the tray 80, the movement of the tray 80 to the accommodation position is restricted.

As illustrated in FIG. 25, the toner cartridge 70m that is a toner cartridge 70 incompatible with the tray 80y is supported on the tray 80y. In this state, the toner cartridge 70m assumes an erroneously mounted orientation relative to the tray 80y.

If the tray 80y is moved from the detachment position toward the accommodation position with the toner cartridge 70m assuming the erroneously mounted orientation relative to the tray 80y, the toner cartridge 70m comes into contact with the developing frame 53 of the rotary main body 90. This restricts the movement of the tray 80y to the accommodation position and the movement of the toner cartridge 70m to the mounted position. In other words, the first tray supporting the second cartridge is restricted from moving to the second position, and the second tray supporting the first cartridge is restricted from moving to the fourth position.

With the toner cartridge 70m assuming the erroneously mounted orientation relative to the tray 80y, a distance D2 from the cartridge holding portion 81 to the uppermost end of the toner cartridge 70m is greater than a shortest distance D1 from the cartridge holding portion 81 to the developing frame 53 in the vertical direction (+Z). When the tray 80y is moved from the detachment position toward the accommodation position, the toner cartridge 70m thus comes into contact with the developing frame 53 of the rotary main body 90.

The toner cartridge 70 assuming the erroneously mounted orientation may be brought into contact with the frame 16 accommodating the rotary main body 90. As illustrated in FIG. 26, when the tray 80y is moved from the detachment position toward the accommodation position with the toner cartridge 70m assuming the erroneously mounted orientation relative to the tray 80y, the contact of the toner cartridge 70m with the frame 16 restricts the movement of the tray 80 to the accommodation position.

With the toner cartridge 70m assuming the erroneously mounted orientation relative to the tray 80y, a distance D4 from the toner holding portion 81 to the uppermost end of the toner cartridge 70m is greater than a shortest distance D3 from the cartridge holding portion 81 to the top end of the opening 16a of the frame 16 in the vertical direction.

In other words, in the image forming apparatus 1 according to the present embodiment, when the tray 80 supporting a wrong toner cartridge 70 is moved from the detachment position to the accommodation position, the toner cartridge 70 comes into contact with the rotary main body 90 (developing frame 53) or the frame 16. In such a case, the moving device 85 may be stopped. Alternatively, the motor M2 may be stopped.

As described above, in the present embodiment, when the tray 80 supporting a wrong toner cartridge 70 is moved from the detachment position to the accommodation position, the toner cartridge 70 comes into contact with the rotary main body 90 (developing frame 53) or the frame 16, whereby the movement of the tray 80 to the accommodation position is restricted. This can restrict movement of the wrong toner cartridge 70 to the mounted position relative to the developing frame 53.

While the mounting of the toner cartridge 70m on the tray 80y has been described, the movement of the trays 80y to 80k to their accommodation position is similarly restricted when incompatible toner cartridges 70 are mounted on the trays 80y to 80k.

### (Prevention of Erroneous Mounting by Color)

The image forming apparatus 1 according to the present embodiment includes a color-based erroneous mounting prevention configuration. Hereinafter, colors will be described using the Munsell color system (100 hues).

Specifically, colors are divided into 100 hues and 10 values for classification. The colors can be measured using instruments such as spectrophotometers and colorimeters.

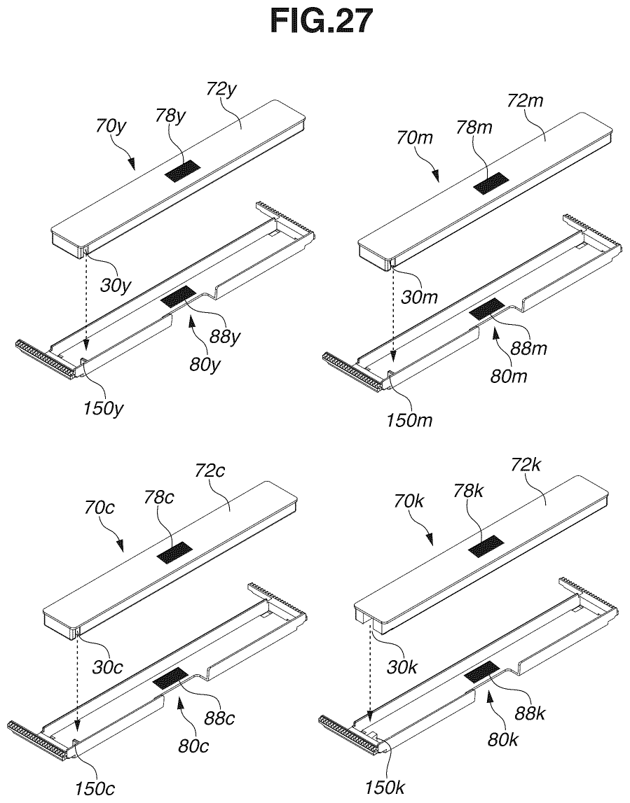

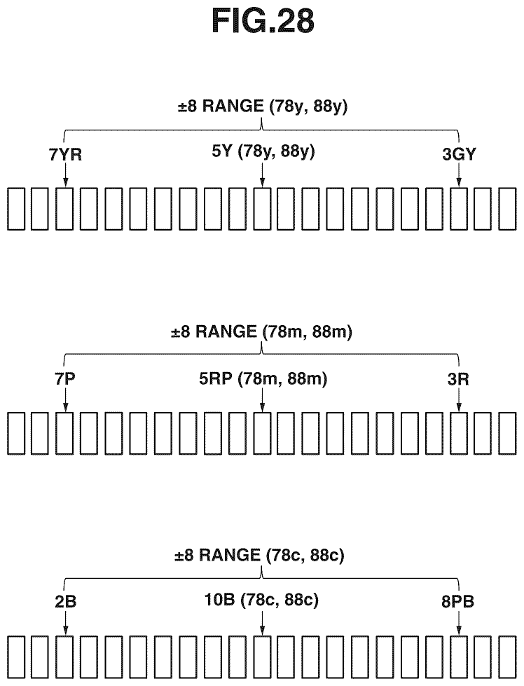

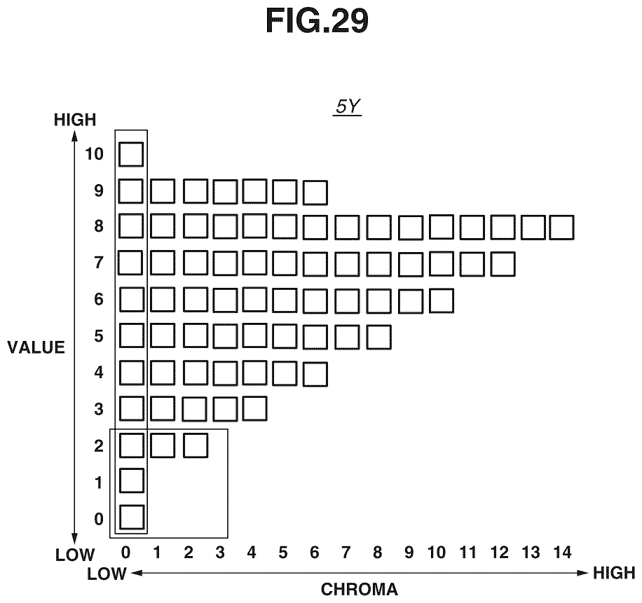

The color-based erroneous mounting prevention configuration according to the present embodiment will be described with reference to FIGS. 27, 28, and 29. FIG. 27 is a perspective view illustrating indicators on the toner cartridges 70 and the trays 80. FIG. 28 is a diagram illustrating the closeness of hues of the toner cartridges 70 and the trays 80 according to the present embodiment. FIG. 29 is a diagram illustrating the color range of the toner cartridge 70k and the tray 80k.

In the present embodiment, as illustrated in FIG. 27, labels 78 are attached to frames 72 of the toner cartridges 70 as indicators. Moreover, labels 88 are attached as indicators on the trays 80.

One of a label 78y, a label 78m, a label 78c, and a label 78k may be referred to as a first cartridge indicator, one of the remaining three a second cartridge indicator, one of the remaining two a third cartridge indicator, and the last one a fourth cartridge indicator.

One of a label 88y, a label 88m, a label 88c, and a label 88k may be referred to as a first tray indicator, one of the remaining three a second tray indicator, one of the remaining two a third tray indicator, and the last one a fourth tray indicator.

Between the tray 80 and the compatible toner cartridge 70, the toner color, the color of the label 78, and the color of the label 88 are desirably similar.

In the present embodiment, the toners, the labels 78, and the labels 88 have the following Munsell values: the yellow toner (5Y 8/14), the label 78y (5Y 8/14), the label 88y (5Y 8/14), the magenta toner (5RP 5/14), the label 78m (5RP 5/14), the label 88m (5RP 5/14), the cyan toner (10B 6/10), the label 78c (10B 6/10), and the label 88c (10C 6/10). Moreover, the black toner (N1.0), the label 78k (N1.0), and the label 88k (N1.0). For example, (5Y 8/14) represents hue 5Y, value 8, and chroma 14.

Next, the characteristics of the color settings of the toners, labels 78, and labels 88 according to the present embodiment will be described. The label 78y has a hue closer to that of the label 88y than to those of the labels 88m and 88c. The label 78m has a hue closer to that of the label 88m than to those of the labels 88y and 88c. The label 78c has a hue closer to that of the label 88c than to those of the labels 88y and 88m. In other words, the hue of the first cartridge indicator is closer to that of the first tray indicator than to that of the second tray indicator. The hue of the second cartridge indicator is closer to that of the second tray indicator than to that of the first tray indicator. This facilitates recognizing the correspondence of the labels 78 and the labels 88 between the trays 80 and the compatible toner cartridges 70.

As illustrated in FIG. 28, the hues of the labels 78y to 78c according to the present embodiment fall within the ±8 ranges of the labels 88y to 88c. For example, the hue (5Y) of the label 78y according to the present embodiment falls within the ±8 hue range (7YR to 3GY) of the hue (5Y) of the label 88y. This makes the correspondence of the labels 78 and 88 easier to recognize between the trays 80 and the compatible toner cartridges 70.

The hue of the label 78y according to the present embodiment is closer to that of the yellow toner than to those of the magenta toner and cyan toner. The hue of the label 78m is closer to that of the magenta toner than to those of the yellow toner and cyan toner. The hue of the label 78c is closer to that of the cyan toner than to those of the yellow toner and magenta toner. The colors of the toners contained in the toner cartridges 70 can thus be easily recognized.

Moreover, the hues of the labels 78 fall within the +8 ranges of the toner hues. For example, the hue (5Y) of the label 78y according to the present embodiment falls within the #8 range (7YR to 3GY) of the hue (5Y) of the yellow toner. The colors of the toners contained in the toner cartridges 70 can thus be easily recognized.

The hue of the label 88y according to the present embodiment is closer to that of the yellow toner than to those of the magenta toner and cyan toner. The hue of the label 88m is closer to that of the magenta toner than to those of the yellow toner and cyan toner. The hue of the label 88c is closer to that of the cyan toner than to those of the yellow toner and magenta toner. The correspondence between the trays 80 and the toner colors can thus be easily recognized.

Moreover, the hues of the labels 88 fall within the ±8 ranges of the toner hues. For example, the hue (5Y) of the label 88y according to the present embodiment falls within the ±8 range (7YR to 3GY) of the hue (5Y) of the yellow toner. The correspondence between the trays 80 and the toner colors can thus be easily recognized.

In the present embodiment, the color (N1.0) of the black toner, the color (N1.0) of the label 78k, and the color (N1.0) of the table 88k are colors with chroma N or a value in the range of 2 and less. For example, FIG. 29 illustrates the colors of hue 5Y, of which 13 colors are classified as black. In other words, in all hues (100), colors with chroma N or a value in the range of 2 and less are classified as black.

In the present embodiment, the color of the yellow toner, the color of the label 78y, the color of the label 88y, the color of the magenta toner, the color of the label 78m, the color of the label 88m, the color of the cyan toner, the color of the label 78c, and the color of the label 88c have a chroma of greater than 0 and a value of greater than 2.

Limiting the colors of the black toner, the label 78k, and the label 88k to chroma N or a value in the range of 2 and less makes the correspondence of the black toner, the label 78k, and the label 88k easy to recognize.

In the present embodiment, the label 78 and the label 88 are attached to the toner cartridge 70 and the tray 80, respectively. However, parts or all of the toner cartridge 70 and the tray 80 may be configured as indicators without the labels 78 and 88. The label 78 may be attached to any position of the toner cartridge 70. The label 88 may be attached to any position of the tray 80. For example, the label 88 may be attached to the side wall 100b.

Instead of attaching the tables 78 and 88, resin sheets may be attached to the tray 80 and the toner cartridge 70 as indicators.

The foregoing configuration can reduce the possibilities of incompatible toner cartridges 70 being erroneously mounted on the trays 80.

### (Tray Shape)

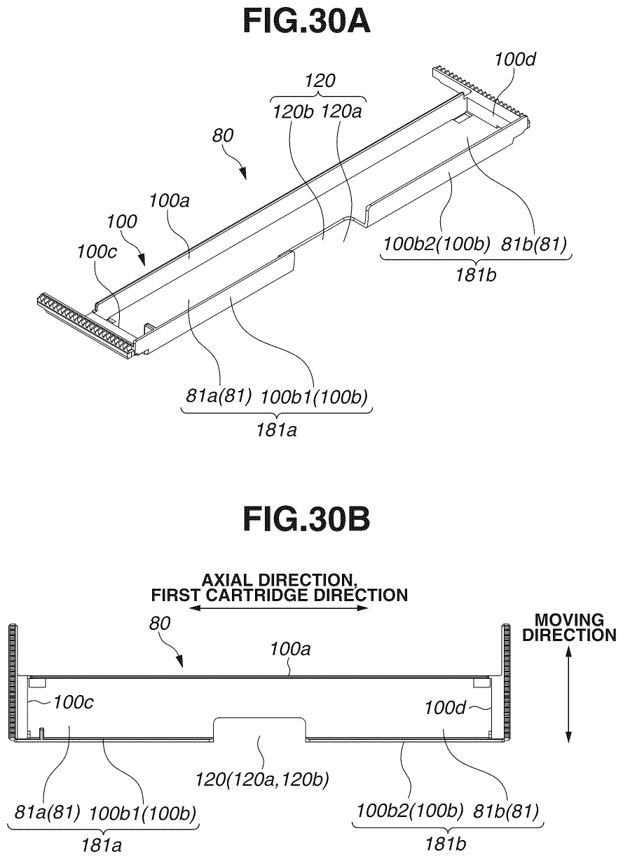

A shape of the tray 80 for facilitating the detachment of the toner cartridge 70 from the tray 80 will be described with reference to FIGS. 30A and 30B. FIG. 30A is a perspective view illustrating the shape of the tray 80. FIG. 30B is a plan view illustrating the shape of the tray 80.

With the toner cartridge 70 mounted on the tray 80, surfaces of the toner cartridge 70 are covered by the cartridge holding portion 81 and the side walls 100. Openings (exposure portions) such as holes and grooves are then formed in the cartridge holding portion 81 or the side walls 100 to expose the surfaces of the toner cartridge 70. This facilitates the user to touch the toner cartridge 70, whereby the toner cartridge 70 can be more easily detached from the tray 80.

The tray 80 includes a side wall 100 and the cartridge holding portion 81 as opposed portions 181 that are opposed to the toner cartridge supported in the first orientation and extend in a predetermined direction. More specifically, the tray 80 includes a bottom wall 81a and a side wall 100b1 as a first opposed portion 181a that is opposed to the toner cartridge 70 supported in the first orientation and extends in the predetermined direction. The bottom wall 81a is a part of the cartridge holding portion 81, and the side wall 100b1 is a part of the side wall 100b.

The bottom wall 81a and the side wall 100b1 extend in the first cartridge direction of the toner cartridge 70 assuming the normal orientation relative to the tray 80. With the toner cartridge 70 assuming the normal orientation relative to the tray 80, the axial direction of the rotation axis 90C is parallel to the first cartridge direction of the toner cartridge 70.

As can be seen from FIG. 19A, with the toner cartridge 70 supported by the tray 80 in the normal orientation, the length of the first opposed portion 181a in the first cartridge direction is smaller than that of the toner cartridge 70. The first opposed portion 181a adjoins a space 120 in the first cartridge direction.

More specifically, the space 120 includes a space 120b adjoining the bottom wall 81a and a space 120a adjoining the side wall 100b1 in the first cartridge direction. In a state where the tray 80 supporting the toner cartridge 70 is located at the detachment position, the toner cartridge 70 is exposed via the space 120 (space 120a and space 120b) (see FIG. 19A). The user can touch the toner cartridge 70 exposed via the space 120. While in the present embodiment the space 120a and the space 120b are continuous, the spaces 120a and 120 may be discontinuous.

The tray 80 further includes a bottom wall 81b and a side wall 100b2 as a second opposed portion 181b that is opposed to the toner cartridge 70 supported in the first orientation and extends in the predetermined direction. The bottom wall 81b is a part of the cartridge holding portion 81. The side wall 100b2 is a part of the side wall 100b. The bottom wall 81b and the side wall 100b2 extend in the first cartridge direction of the toner cartridge 70 assuming the normal orientation relative to the tray 80.

As can be seen from FIG. 19A, with the toner cartridge 70 supported by the tray 80 in the normal orientation, the length of the second opposed portion 181b in the first cartridge direction is smaller than that of the toner cartridge 70. The second opposed portion 181b adjoins the space 120 in the first cartridge direction. The bottom wall 81b adjoins the space 120b, and the side wall 100b2 adjoins the space 120a, in the first cartridge direction.

The bottom walls 81a and 81b are opposed to the bottom portion (bottom surface) 20 of the toner cartridge 70 supported by the tray 80 in the normal orientation. The side walls 100b1 an 100b2 are opposed to the side portion (side surface) 25 of the toner cartridge 70 supported by the tray 80 in the normal orientation. The side portion 25 of the toner cartridge 70 can be said to extend in a direction intersecting the bottom portion 20.

The side walls 100b1 and 100b2 are located downstream of the cartridge holding portion 81 in the moving direction of the tray 80 from the accommodation position to the detachment position. In other words, the side walls 100b1 and 100b2 are located downstream of the toner cartridge 70 supported by the tray 80 in the normal orientation in the moving direction of the tray 80 from the accommodation position to the detachment position.

The space 120 is located between the first opposed portion 181a and the second opposed portion 181b in the axial direction of the rotation axis 90C. More specifically, the space 120a is located between the side walls 100b1 and 100b2, and the space 120b is located between the bottom walls 81a and 81b.

Such a configuration facilitates the detachment of the toner cartridge 70 using the portion of the toner cartridge 70 exposed via the space 120.

In the present embodiment, as illustrated in FIG. 7A, with the toner cartridge 70 assuming the first orientation, the top end of the toner cartridge 70 in the vertical direction is located above the top ends of the side walls 100b1 and 100b2. Since the top end of the toner cartridge 70 is exposed, the toner cartridge 70 can be easily detached.

In the present embodiment, the space 120 includes the space 120a and the space 120b. However, one of the spaces 120a and 120b may be omitted. In other words, the space where the toner cartridge 70 is exposed only needs to be located either between the bottom walls 81a and 81b or between the side walls 100b1 and 100b2. In the case where the space 120 includes the spaces 120a and 120b, the user can easily touch the toner cartridge 70 compared to the case where the space 120 includes one of the spaces 120a and 120b.

While the tray 80 includes the first opposed portion 181a and the second opposed portion 181b, one of the first opposed portion 181a and the second opposed portion 181b may be omitted. Even in such a case, one of the spaces 120a and 120b may be omitted. In other words, the space 120b may adjoin the other of the bottom walls 81a and 81b. With one of the side walls 100b1 and 100b2 omitted, the space 120b may adjoin the other of the side walls 100b1 and 100b2.

Moreover, in the present embodiment, the first opposed portion 181a and the second opposed portion 181b extend in the first cartridge direction of the toner cartridge 70 supported by the tray 80 in the normal orientation as the predetermined direction. However, the tray 80 may include a first opposed portion and a second opposed portion that extend in the second cartridge direction of the toner cartridge 70 supported by the tray 80 in the normal orientation as the predetermined direction. Alternatively, the tray 80 may include the first opposed portion and the second opposed portion that extend in the first cartridge direction of the toner cartridge 70 supported by the tray 80 in the normal orientation as the predetermined direction, and further include the first opposed portion and the second opposed portion that extend in the second cartridge.

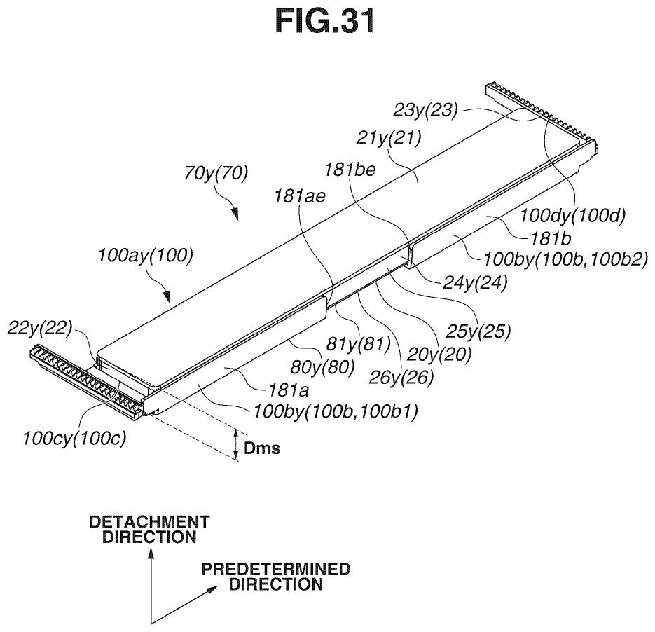

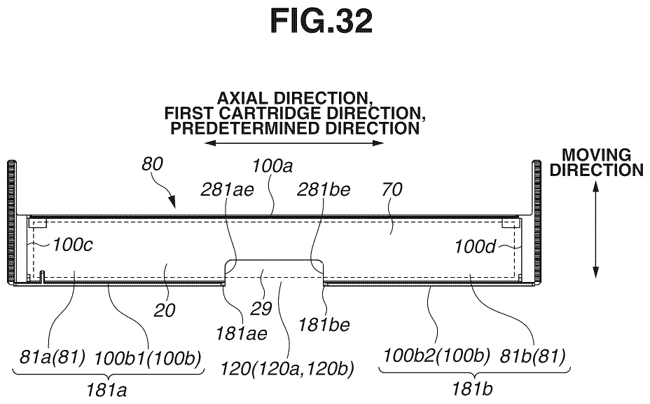

Next, the characteristics of the tray 80 when the toner cartridge 70 is mounted on the tray 80 will be described with reference to FIGS. 31 and 32. FIG. 31 is a perspective view illustrating a state where the toner cartridge 70 is supported by the tray 80 in the first orientation. FIG. 32 is a plan view of the state where the toner cartridge 70 is supported by the tray 80 in the first orientation.

The direction in which the toner cartridge 70 supported by the tray 80 in the first orientation is detached will be referred to as a detachment direction. The detachment direction is desirably a vertical direction. The predetermined direction in which the first opposed portion 181a extends is a direction orthogonal to the detachment direction. The predetermined direction is desirably a horizontal direction. The first opposed portion 181 includes an end 181ae. The end 181ae is a downstream end of the first opposed portion 181 in the predetermined direction. In the predetermined direction, a part (exposed portion 26y) of the cartridge is located downstream of the downstream end 181ae in the predetermined direction in which the first opposed portion 181a extends. Specifically, in the predetermined direction, the part (exposed portion 26y) of the cartridge is exposed via the space adjoining the end 181ae in the predetermined direction. In other words, in the predetermined direction, the part (exposed portion 26y) of the cartridge is exposed via the space downstream of the end 181ae in the predetermined direction.

The second opposed portion 181b includes an end 181be. The end 181be is an upstream end of the second opposed portion 181b in the predetermined direction. In the predetermined direction, the part (exposed part) 26y of the cartridge is located upstream of the upstream end of the second opposed portion 181b. Specifically, the exposed portion 26y that is a part of the cartridge and exposed is located between the first opposed portion 181a and the second opposed portion 181b in the predetermined direction.

In other words, in the predetermined direction, the part (exposed portion 26y) of the cartridge is exposed via the space between the end 181ae and the end 181be in the predetermined direction.

The side wall 100b1 will be referred to as a first side wall 100b1, and the side wall 100b2 a second side wall 100b2. When the toner cartridge 70 is supported by the tray 80 in the first orientation, the first side wall 100b1 and the second side wall 100b2 are opposed to the side surface 25 of the toner cartridge 70. The first opposed portion 181a includes the first side wall 100b1, and the second opposed portion 181b includes the second side wall 100b2. The exposed portion 26y that is a part of the toner cartridge 70 is located between the first side wall 100b1 and the second side wall 100b2 in the predetermined direction in which the first opposed portion 181a extends.

The bottom wall 81a will be referred to as a first bottom wall 81a, and the bottom wall 81b a second bottom wall 81b. As illustrated in FIG. 32, when the toner cartridge 70 is supported by the tray 80 in the first orientation, the first bottom wall 81a and the second bottom wall 81b are opposed to the bottom surface 20 of the toner cartridge 70. The first opposed portion 181a includes the first bottom wall 81a. The second opposed portion 181b includes the second bottom wall 81b.

The first bottom wall 81a includes an end 281ae. The end 281ae is a downstream end of the first bottom wall 81a in the predetermined direction. In the predetermined direction, a part (exposed portion 29) of the cartridge is located downstream of the downstream end of the first bottom wall 81a. The second bottom wall 81b includes an end 281be. The end 281be is an upstream end of the second bottom wall 81b in the predetermined direction. In the predetermined direction, the part (exposed portion 29) of the cartridge is located upstream of the upstream end of the second bottom wall 81b. In other words, the exposed portion 29 that is a part of the toner cartridge 70 is located between the first bottom wall 81a and the second bottom wall 81b in the predetermined direction.

### Modifications

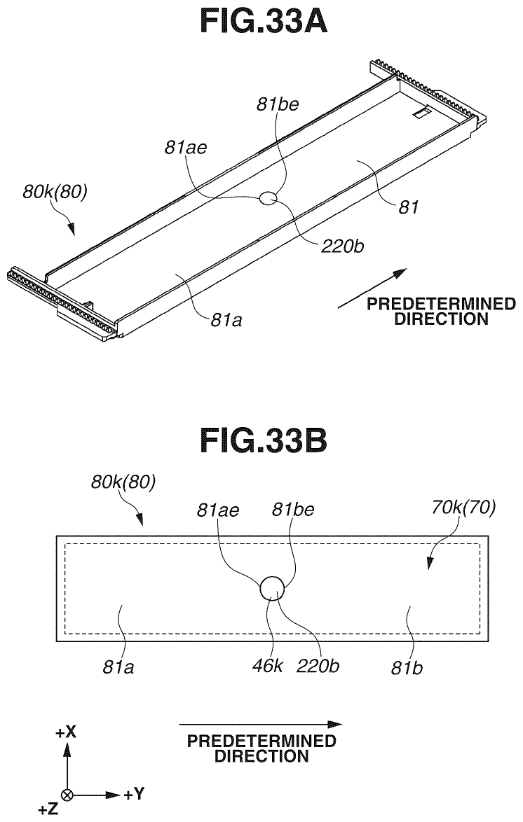

While the present embodiment has dealt with the tray 80 shaped as illustrated in FIGS. 30A and 30B, the tray 80 may be shaped as illustrated in FIGS. 33A and 33B. FIG. 33A is a perspective view of the tray 80. FIG. 33B is a plan view when the toner cartridge 70 is mounted on the tray 80.

As illustrated in FIG. 33A, there is a space 220b between the bottom wall 81a and the bottom wall 81b. More specifically, a cutout 220b is formed in the tray 80. As illustrated in FIG. 33B, with the toner cartridge 70 supported by the tray 80 in the first orientation, an exposed portion 46k that is a part of the toner cartridge 70 is exposed.

The bottom wall 81a includes an end 81ae. The end 81ae is a downstream end of the bottom wall 81a in the predetermined direction. In the predetermined direction, the part (the exposed portion 46k) of the cartridge is located downstream of the downstream end (end 81ae1) in the predetermined direction in which the bottom wall 81a extends. The bottom wall 81b includes an end 81be. The end 81be is an upstream end of the bottom wall 81b in the predetermined direction. The part (exposure portion 46k) of the cartridge is located upstream of the upstream end of the bottom wall 81b in the predetermined direction. In other words, the exposed portion 46k that is a part of the cartridge and exposed is located between the bottom walls 81a and 81b in the predetermined direction.

Here, the bottom wall 81a will be referred to as a first bottom wall, and the bottom wall 81b a second bottom wall. With the toner cartridge 70 supported by the tray 80, the direction in which the bottom wall 81a and the bottom wall 81b are opposed to the bottom surface 20 of the toner cartridge 70 will be referred to as a second direction. Each of the bottom walls 81a and 81b extends in the predetermined direction intersecting the detachment direction of the toner cartridge 70. With the toner cartridge 70 assuming the first orientation, a part of the toner cartridge 70 is located between the first bottom wall and the second bottom wall in the predetermined direction.

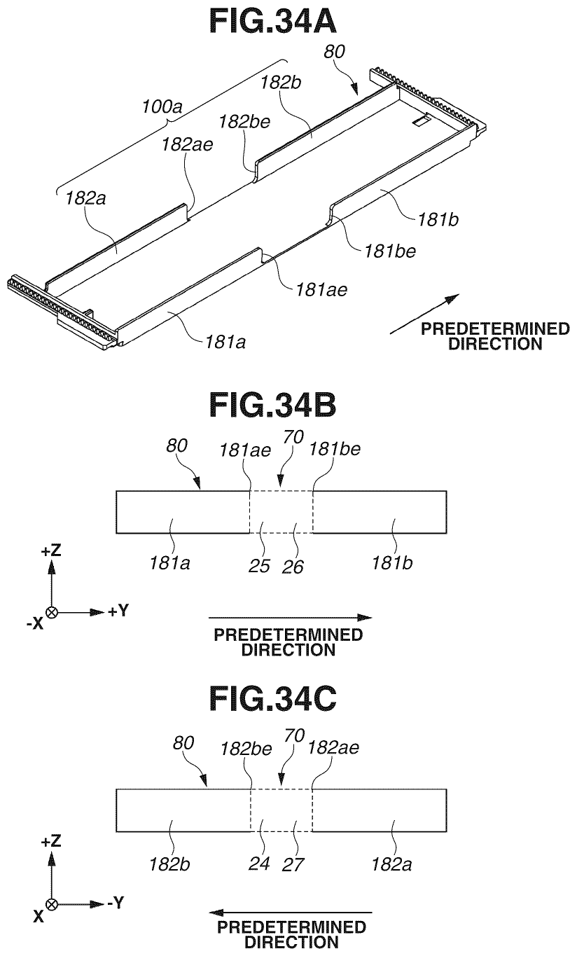

While the present embodiment has dealt with the tray 80 shaped as illustrated in FIGS. 30A and 30B, the tray 80 may be shaped as illustrated in FIGS. 34A to 34C. FIG. 34A is a perspective view of the tray 80. FIGS. 34B and 34C are schematic diagrams illustrating a state where the toner cartridge 70 is supported by the tray 80 in the first orientation. The side wall 100a includes a third opposed portion 182a and a fourth opposed portion 182b. As illustrated in FIG. 34B, a first opposed portion 181a and a second opposed portion 181b are opposed to the side portion 25 of the toner cartridge 70. As illustrated in FIG. 34C, the third opposed portion 182a and the fourth opposed portion 182b are opposed to the side portion 24. The first opposed portion 181a and the second opposed portion 181b are located downstream of the third opposed portion 182a and the fourth opposed portion 182b in the moving direction of the tray 80 from the accommodation position to the detachment position.

The first opposed portion 181a includes an end 181ae. The end 181ae is a downstream end of the first opposed portion 181a in the predetermined direction. In the predetermined direction, a part (exposed portion 26y) of the cartridge is located downstream of the downstream end in the predetermined direction in which the first opposed portion 181a extends. The second opposed portion 181b includes an end 181be. The end 181be is an upstream end of the second opposed portion 181b in the predetermined direction. The part (exposed portion 26y) of the cartridge is located upstream of the upstream end of the second opposed portion 181b in the predetermined direction. In other words, the exposed portion 26y that is a part of the cartridge and exposed is located between the first opposed portion 181a and the second opposed portion 181b in the predetermined direction.

The third opposed portion 182a includes an end 182ae. The end 182ae is a downstream end of the third opposed portion 182a in the predetermined direction. In the predetermined direction, a part (exposed portion 27y) of the cartridge is located downstream of the downstream end in the predetermined direction in which the third opposed portion 182a extends. The fourth opposed portion 182b includes an end 182be. The end 182be is an upstream end of the fourth opposed portion 182b in the predetermined direction. The part (exposed portion 27y) of the cartridge is located upstream of the upstream end of the fourth opposed portion 182b in the predetermined direction. In other words, the exposed portion 27y that is a part of the cartridge and exposed is located between the third opposed portion 182a and the fourth opposed portion 182b in the predetermined direction.

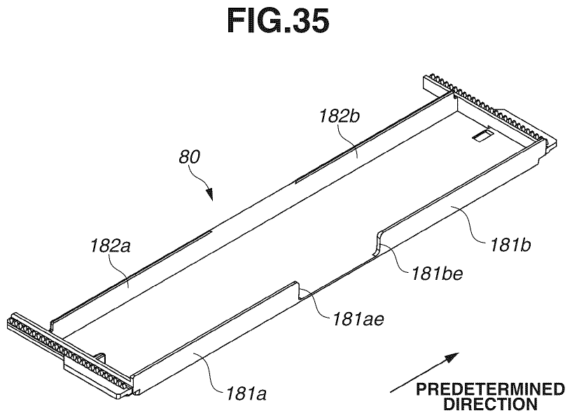

The third opposed portion 182a and the fourth opposed portion 182b illustrated in FIGS. 34A to 34C are not continuous in the predetermined direction. As a modification of the tray 80 of FIGS. 34A to 34C, the third opposed portion 182a and the fourth opposed portion 182b may be configured to be continuous as illustrated in FIG. 35. The configuration of the tray 80 of FIG. 35 differs from that of the tray 80 of FIGS. 34A to 34C only in this respect.

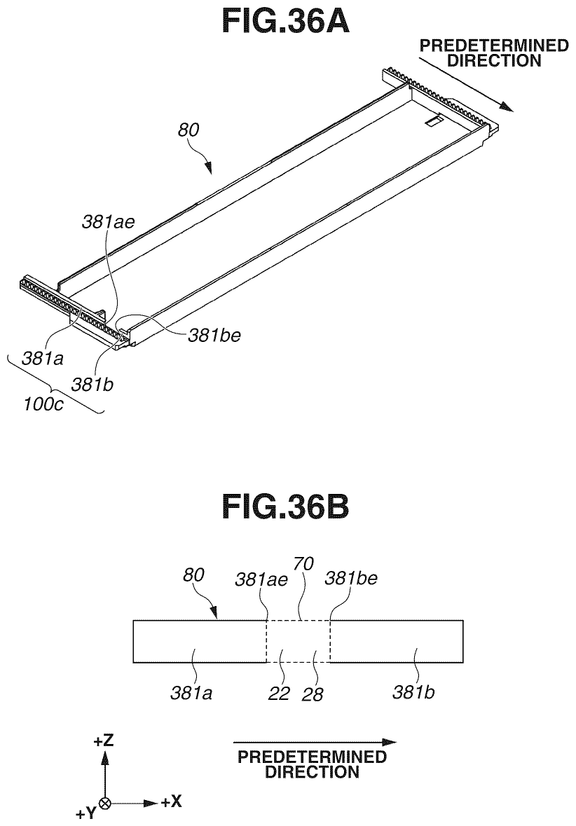

In the present embodiment, the side wall 100b includes the first opposed portion and the second opposed portion. However, the side wall 100c may include a first opposed portion 381a and a second opposed portion 381b as illustrated in FIGS. 36A and 36B. FIG. 36A is a perspective view of the tray 80. FIG. 36B is a schematic diagram illustrating a state where the toner cartridge 70 is supported by the tray 80 in the first orientation. The first opposed portion 381a and the second opposed portion 381b are opposed to the side portion 22 of the toner cartridge 70. The first opposed portion 381a and the second opposed portion 381b extend in the predetermined direction.

The first opposed portion 381a includes an end 381ae. The end 381ae is a downstream end of the first opposed portion 381a in the predetermined direction. In the predetermined direction, a part (exposed portion 28) of the cartridge is located downstream of the downstream end in the predetermined direction in which the first opposed portion 381a extends. The second opposed portion 381b includes an end 381be. The end 381be is an upstream end of the second opposed portion 381b in the predetermined direction. The part (exposed portion 28) of the cartridge is located upstream of the upstream end of the second opposed portion 381b in the predetermined direction. In other words, the exposed portion 28 that is a part of the cartridge and exposed is located between the first opposed portion 381a and the second opposed portion 381b in the predetermined direction.

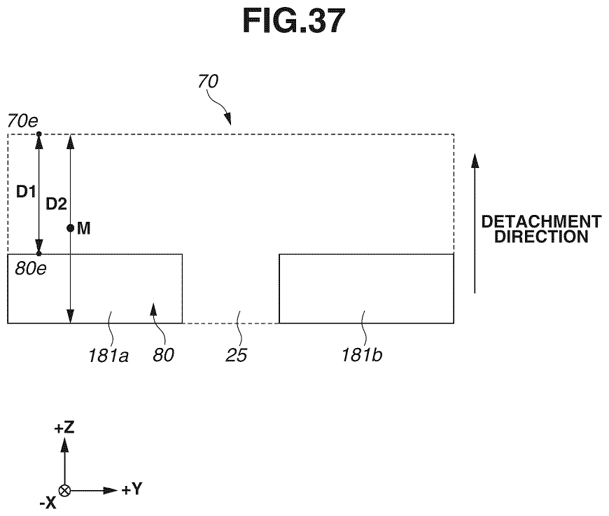

Next, FIG. 37 that illustrates a modification of the present embodiment will be described. FIG. 37 is a schematic diagram of the toner cartridge 70 and the tray 80. In FIG. 37, the toner cartridge 70 is supported by the tray 80 in the first orientation. The downstream end of the first opposed portion in the detachment direction of the toner cartridge 70 will be referred to as a first end 80e. With the toner cartridge 70 supported by the tray 80 in the first orientation, the downstream end of the toner cartridge 70 in the detachment direction will be referred to as a cartridge end 70e. The symbol M illustrated in FIG. 37 denotes a position one half the length of the toner cartridge 70 in the detachment direction. With the toner cartridge 70 supported by the tray 80 in the first orientation, a distance D1 between the first end 80e and the cartridge end 70e is greater than one half of a length D2 of the toner cartridge 70 in the detachment direction. With such a configuration, the user can easily detach the toner cartridge 70 since the exposed portion of the toner cartridge 70 is wide.

### OTHER EMBODIMENTS

The foregoing embodiment has dealt with the configuration where the tray 80 is moved from the accommodation position to the detachment position by the driving device, biasing member, or the like of the apparatus main body 1A without the user operating the tray 80. Alternatively, a configuration may be employed in which the user grips and pulls out the tray 80 from the accommodation position to the detachment position (i.e., manually moves the support member) with the rotary main body 90 in the replacement orientation. Even in such a case, operability improves compared to the case of directly inserting and removing the toner cartridge into/from the apparatus main body, since the user can mount and dismount the toner cartridge 70 on/from the tray 80 pulled out of the apparatus main body.

The foregoing embodiment has dealt with the configuration where the rotary main body 90 includes the four developing units 50y to 50k and can form color images using the four color toners. However, the rotary main body 90 may include three or fewer developing units, or five or more developing units. In such cases, the numbers and arrangement of trays and toner cartridges can be modified as appropriate based on the number of developing units. For example, while the foregoing embodiment has dealt with the configuration where the four toner cartridges 70y to 70k can be detachably mounted to the rotary main body 90, the rotary main body 90 may be configured to mount only one toner cartridge 70k.

### Summary of Present Disclosure

The present disclosure includes at least the following configurations.

### Configuration 1

An image forming apparatus to which a cartridge accommodating a developer is detachably mountable, the image forming apparatus comprising:
a rotary configured to be rotatable about a rotation axis extending in an axial direction, the rotary including a developing chamber configured to accommodate the developer supplied from the cartridge; and
a tray capable of detachably supporting the cartridge so that the cartridge assumes a first orientation, the tray including a first opposed portion configured to be opposed to the cartridge in the first orientation and extend in a predetermined direction, the tray being configured to be displaced relative to the rotary to a first position where the cartridge supported in the first orientation is located outside the rotary and a second position where the cartridge supported in the first orientation is located inside the rotary,
wherein a detachment direction is a direction in which the cartridge supported by the tray in the first orientation is detached from the tray,
wherein the predetermined direction is a direction orthogonal to the detachment direction, and
wherein with the cartridge in the first orientation, a part of the cartridge is located downstream, in the predetermined direction, of a downstream end of the first opposed portion in the predetermined direction.

### Configuration 2

The image forming apparatus according to Configuration 1, wherein the tray includes a second opposed portion configured to be opposed to the cartridge in the first orientation and extend in the predetermined direction, and with the cartridge in the first orientation, the part of the cartridge is located between the first opposed portion and the second opposed portion in the predetermined direction.

### Configuration 3

The image forming apparatus according to Configuration 2,
wherein the cartridge includes a bottom surface,
wherein the tray includes a first bottom wall and a second bottom wall configured to be opposed to the bottom surface in a case where the cartridge is supported by the tray in the first orientation,
wherein the first opposed portion includes the first bottom wall, and the second opposed portion includes the second bottom wall, and
wherein with the cartridge in the first orientation, the part of the cartridge is located between the first bottom wall and the second bottom wall in the predetermined direction.

### Configuration 4

The image forming apparatus according to Configuration 2,
wherein the cartridge includes a bottom surface and a side surface extending in a direction intersecting the bottom surface,
wherein the tray includes a first side wall and a second side wall configured to be opposed to the side surface in a case where the cartridge is supported by the tray in the first orientation,
wherein the first opposed portion includes the first side wall, and the second opposed portion includes the second side wall, and
wherein the part of the cartridge is located between the first side wall and the second side wall in the predetermined direction.

### Configuration 5

The image forming apparatus according to Configuration 4, wherein the first side wall and the second side wall are located downstream of the cartridge assuming the first orientation in a moving direction of the tray from the second position to the first position.

### Configuration 6

The image forming apparatus according to Configuration 5, wherein with the cartridge in the first orientation, an upper end of the cartridge is located above an upper end of the first side wall and an upper end of the second side wall in a vertical direction.

### Configuration 7

The image forming apparatus according to Configuration 2,
wherein the cartridge includes a bottom surface and a side surface extending in a direction intersecting the bottom surface,
wherein the tray includes a first bottom wall and a second bottom wall configured to be opposed to the bottom surface, and a first side wall and a second side wall configured to be opposed to the side surface, in a case where the cartridge is supported by the tray in the first orientation,
wherein the first opposed portion includes the first bottom wall and the first side wall, and the second opposed portion includes the second bottom wall and the second side wall,
wherein the part of the cartridge is located between the first bottom wall and the second bottom wall in the predetermined direction, and
wherein the part of the cartridge is located between the first side wall and the second side wall in the predetermined direction.

### Configuration 8

The image forming apparatus according to Configuration 7, wherein the first side wall and the second side wall are located downstream of the cartridge assuming the first orientation in a moving direction of the tray from the second position to the first position.

### Configuration 9

The image forming apparatus according to Configuration 8, wherein with the cartridge in the first orientation, an upper end of the cartridge is located above an upper end of the first side wall and an upper end of the second side wall in a vertical direction.

### Configuration 10

The image forming apparatus according to any one of Configurations 2 to 9, wherein the first opposed portion and the second opposed portion extend in a longitudinal direction of the cartridge assuming the first orientation.

### Configuration 11

The image forming apparatus according to Configuration 1,
wherein the cartridge includes a bottom surface,
wherein the tray includes a first bottom wall configured to be opposed to the bottom surface in a case where the cartridge is supported by the tray in the first orientation, and
wherein the first opposed portion includes the first bottom wall.

### Configuration 12

The image forming apparatus according to Configuration 1,
wherein the cartridge includes a bottom surface and a side surface extending in a direction intersecting the bottom surface,
wherein the tray includes a first side wall configured to be opposed to the side surface in a case where the cartridge is supported by the tray in the first orientation, and
wherein the first opposed portion includes the first side wall.

### Configuration 13

The image forming apparatus according to Configuration 12, wherein the first side wall is located downstream of the cartridge assuming the first orientation in a moving direction of the tray from the second position to the first direction.

### Configuration 14

The image forming apparatus according to Configuration 13, wherein with the cartridge in the first orientation, an upper end of the cartridge is located above an upper end of the first side wall in a vertical direction.

### Configuration 15

The image forming apparatus according to Configuration 2,
wherein the cartridge includes a bottom surface and a side surface extending in a direction intersecting the bottom surface,
wherein the tray includes a first bottom wall configured to be opposed to the bottom surface, and a first side wall configured to be opposed to the side surface, in a case where the cartridge is supported by the tray in the first orientation, and
wherein the first opposed portion includes the first bottom wall and the first side wall.

### Configuration 16

The image forming apparatus according to Configuration 15, wherein the first side wall is located downstream of the cartridge assuming the first orientation in a moving direction of the tray from the second position to the first position.

### Configuration 17

The image forming apparatus according to Configuration 16, wherein with the cartridge in the first orientation, an upper end of the cartridge is located above an upper end of the first side wall in a vertical direction.

### Configuration 18

An image forming apparatus to which a cartridge accommodating a developer is detachably mountable, the image forming apparatus comprising:
a rotary configured to be rotatable about a rotation axis extending in an axial direction, the rotary including a developing chamber configured to accommodate the developer supplied from the cartridge; and
a tray capable of detachably supporting the cartridge so that the cartridge assumes a first orientation, the tray including a first opposed portion configured to be opposed to the cartridge in the first orientation in a first direction and extend in a predetermined direction, the tray being configured to be displaced relative to the rotary to a first position where the cartridge supported in the first orientation is located outside the rotary and a second position where the cartridge supported in the first orientation is located inside the rotary,
wherein a detachment direction is a direction in which the cartridge supported by the tray in the first orientation is detached,
wherein a first end is a downstream end of the first opposed portion in the detachment direction,
wherein a cartridge end is a downstream end of the cartridge in the detachment direction with the cartridge supported by the tray in the first orientation, and
wherein with the cartridge supported by the tray in the first orientation, a distance between the first end and the cartridge end is greater than one half of a length of the cartridge in the detachment direction.

The present disclosure is not limited to the above embodiments and various changes and modifications can be made within the spirit and scope of the present disclosure. Therefore, to apprise the public of the scope of the present disclosure, the following claims are made.

According to the present disclosure, a new form of image forming apparatus that is an advancement of the conventional techniques can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image forming apparatus to which a cartridge accommodating a developer is detachably mountable, the image forming apparatus comprising:
a rotary configured to be rotatable about a rotation axis extending in an axial direction, the rotary including a developing chamber configured to accommodate the developer supplied from the cartridge; and
a tray capable of detachably supporting the cartridge so that the cartridge assumes a first orientation, the tray including a first opposed portion configured to be opposed to the cartridge in the first orientation and extend in a predetermined direction, the tray being configured to be displaced relative to the rotary to a first position where the cartridge supported in the first orientation is located outside the rotary and a second position where the cartridge supported in the first orientation is located inside the rotary,
wherein a detachment direction is a direction in which the cartridge supported by the tray in the first orientation is detached from the tray,
wherein the predetermined direction is a direction orthogonal to the detachment direction, and
wherein with the cartridge in the first orientation, a part of the cartridge is located downstream, in the predetermined direction, of a downstream end of the first opposed portion in the predetermined direction.

2. The image forming apparatus according to claim 1, wherein the tray includes a second opposed portion configured to be opposed to the cartridge in the first orientation and extend in the predetermined direction, and with the cartridge in the first orientation, the part of the cartridge is located between the first opposed portion and the second opposed portion in the predetermined direction.

3. The image forming apparatus according to claim 2,
wherein the cartridge includes a bottom surface,
wherein the tray includes a first bottom wall and a second bottom wall configured to be opposed to the bottom surface in a case where the cartridge is supported by the tray in the first orientation,
wherein the first opposed portion includes the first bottom wall, and the second opposed portion includes the second bottom wall, and
wherein with the cartridge in the first orientation, the part of the cartridge is located between the first bottom wall and the second bottom wall in the predetermined direction.

4. The image forming apparatus according to claim 2,
wherein the cartridge includes a bottom surface and a side surface extending in a direction intersecting the bottom surface,
wherein the tray includes a first side wall and a second side wall configured to be opposed to the side surface in a case where the cartridge is supported by the tray in the first orientation,
wherein the first opposed portion includes the first side wall, and the second opposed portion includes the second side wall, and
wherein the part of the cartridge is located between the first side wall and the second side wall in the predetermined direction.

5. The image forming apparatus according to claim 4, wherein the first side wall and the second side wall are located downstream of the cartridge assuming the first orientation in a moving direction of the tray from the second position to the first position.

6. The image forming apparatus according to claim 5, wherein with the cartridge in the first orientation, an upper end of the cartridge is located above an upper end of the first side wall and an upper end of the second side wall in a vertical direction.

7. The image forming apparatus according to claim 2,
wherein the cartridge includes a bottom surface and a side surface extending in a direction intersecting the bottom surface,
wherein the tray includes a first bottom wall and a second bottom wall configured to be opposed to the bottom surface, and a first side wall and a second side wall configured to be opposed to the side surface, in a case where the cartridge is supported by the tray in the first orientation,
wherein the first opposed portion includes the first bottom wall and the first side wall, and the second opposed portion includes the second bottom wall and the second side wall,
wherein the part of the cartridge is located between the first bottom wall and the second bottom wall in the predetermined direction, and
wherein the part of the cartridge is located between the first side wall and the second side wall in the predetermined direction.

8. The image forming apparatus according to claim 7, wherein the first side wall and the second side wall are located downstream of the cartridge assuming the first orientation in a moving direction of the tray from the second position to the first position.

9. The image forming apparatus according to claim 8, wherein with the cartridge in the first orientation, an upper end of the cartridge is located above an upper end of the first side wall and an upper end of the second side wall in a vertical direction.

10. The image forming apparatus according to claim 2, wherein the first opposed portion and the second opposed portion extend in a longitudinal direction of the cartridge assuming the first orientation.

11. The image forming apparatus according to claim 1,
wherein the cartridge includes a bottom surface,
wherein the tray includes a first bottom wall configured to be opposed to the bottom surface in a case where the cartridge is supported by the tray in the first orientation, and
wherein the first opposed portion includes the first bottom wall.

12. The image forming apparatus according to claim 1,
wherein the cartridge includes a bottom surface and a side surface extending in a direction intersecting the bottom surface,
wherein the tray includes a first side wall configured to be opposed to the side surface in a case where the cartridge is supported by the tray in the first orientation, and
wherein the first opposed portion includes the first side wall.

13. The image forming apparatus according to claim 12, wherein the first side wall is located downstream of the cartridge assuming the first orientation in a moving direction of the tray from the second position to the first direction.

14. The image forming apparatus according to claim 13, wherein with the cartridge in the first orientation, an upper end of the cartridge is located above an upper end of the first side wall in a vertical direction.

15. The image forming apparatus according to claim 2,
wherein the cartridge includes a bottom surface and a side surface extending in a direction intersecting the bottom surface,
wherein the tray includes a first bottom wall configured to be opposed to the bottom surface, and a first side wall configured to be opposed to the side surface, in a case where the cartridge is supported by the tray in the first orientation, and
wherein the first opposed portion includes the first bottom wall and the first side wall.

16. The image forming apparatus according to claim 15, wherein the first side wall is located downstream of the cartridge assuming the first orientation in a moving direction of the tray from the second position to the first position.

17. The image forming apparatus according to claim 16, wherein with the cartridge in the first orientation, an upper end of the cartridge is located above an upper end of the first side wall in a vertical direction.

18. An image forming apparatus to which a cartridge accommodating a developer is detachably mountable, the image forming apparatus comprising:
a rotary configured to be rotatable about a rotation axis extending in an axial direction, the rotary including a developing chamber configured to accommodate the developer supplied from the cartridge; and
a tray capable of detachably supporting the cartridge so that the cartridge assumes a first orientation, the tray including a first opposed portion configured to be opposed to the cartridge in the first orientation in a first direction and extend in a predetermined direction, the tray being configured to be displaced relative to the rotary to a first position where the cartridge supported in the first orientation is located outside the rotary and a second position where the cartridge supported in the first orientation is located inside the rotary,
wherein a detachment direction is a direction in which the cartridge supported by the tray in the first orientation is detached,
wherein a first end is a downstream end of the first opposed portion in the detachment direction,
wherein a cartridge end is a downstream end of the cartridge in the detachment direction with the cartridge supported by the tray in the first orientation, and
wherein with the cartridge supported by the tray in the first orientation, a distance between the first end and the cartridge end is greater than one half of a length of the cartridge in the detachment direction.
